(19) United States
(12) Patent Application Publication
(10) Pub. No.: US 2016/0001505 A1
(43) Pub. Date: Jan. 7, 2016

(54) APPARATUS FOR MODELING THREE-DIMENSIONAL OBJECT AND METHOD FOR MODELING THREE-DIMENSIONAL OBJECT

(71) Applicant: MIMAKI ENGINEERING CO., LTD., NAGANO (JP)

(72) Inventors: KUNIO HAKKAKU, NAGANO (JP); AKIRA IKEDA, NAGANO (JP)

(21) Appl. No.: 14/791,485

(22) Filed: Jul. 6, 2015

(30) Foreign Application Priority Data
Jul. 7, 2014 (JP) 2014-139658
May 14, 2015 (JP) 2015-099508

(51) Int. Cl. B29C 67/00; B41J 2/145

(52) U.S. Cl. CPC B29C 67/0059; B41J 2/145; B29C 67/0088; B33Y 10/00

(57) ABSTRACT

An apparatus for modeling a three-dimensional object configured to model a three-dimensional object by a lamination modeling method includes a plurality of heads for colored inks including a curable resin and configured to discharge ink droplets of colored inks having different colors from each other by an inkjet method, an ultraviolet light source, which is a curing unit, and a control unit. When coloring a surface of the three-dimensional object, the control unit enables the plurality of heads for colored inks to discharge the ink droplets, based on an image, to an outer periphery area of the three-dimensional object, which is an area of which a color can be visibly recognized from an outside of the three-dimensional object. When not coloring the surface of the three-dimensional object, the control unit enables at least one of the heads for colored inks to discharge the ink droplets to an inner area.

### CROSS-REFERENCE TO RELATED APPLICATIONS

The present application claims the priority benefit of Japan application serial no. 2014-139658, filed on Jul. 7, 2014, and No. 2015-099508, filed on May 14, 2015. The entirety of each of the above-mentioned patent applications is hereby incorporated by reference herein and made a part of this specification.

### TECHNICAL FIELD

The present disclosure relates to an apparatus for modeling a three-dimensional object and a method for modeling a three-dimensional object.

### DESCRIPTION OF THE BACKGROUND ART

In recent years, a 3D printer configured to model a three-dimensional object has been used for a variety of using applications. Also, a method (inkjet lamination method) of modeling a three-dimensional object by discharging a material for a three-dimensional object from an inkjet head (recording head) has been known (for example, referring to Patent Document 1).

[Patent Document 1] Japanese Patent No. 4,420,685B.

In the inkjet lamination method, the three-dimensional object is modeled by using a head for modeling material configured to discharge ink droplets of ink for modeling a three-dimensional object, a head for support material configured to discharge droplets (ink droplets) becoming a material of a support layer for supporting the three-dimensional object, and the like, for example. For instance, when performing only the modeling without coloring the three-dimensional object, it is possible to model a three-dimensional object by using only the two inkjet heads.

Here, in a modeling apparatus configured to perform a modeling with the inkjet lamination method, a modeling speed of modeling a three-dimensional object in a height direction is about 1 cm/hour to 2 cm/hour. For this reason, when modeling a three-dimensional object having a height of about 10 cm, for example, it takes half a day or longer. Regarding this, it is considered to perform the modeling by using a plurality of heads for modeling material and heads for support material, for example, so as to increase the modeling speed. In this case, however, the apparatus becomes larger and the cost increases, which are inevitable.

For this reason, there are needs for a configuration capable of increasing the modeling speed more appropriately. Therefore, the present disclosure provides an apparatus for modeling a three-dimensional object and a method for modeling a three-dimensional object capable of solving the problem.

### SUMMARY

In recent years, when modeling a three-dimensional object with the inkjet lamination method, it is considered to color a surface of the three-dimensional object with color ink. In this case, the inkjet heads corresponding to the number of color inks to be used are inevitably required, in addition to the head for modeling material and the head for support material. More specifically, inkjet heads corresponding to process colors used for a color expression, for example, four colors of Y (yellow), M (magenta), C (cyan) and K (black) and an inkjet head of white necessary for a color expression by a subtractive color process are further required.

Regarding the above problem, the inventors of the present application considered enabling not only the head for modeling material and the head for support material, but also inkjet heads for colored inks to discharge the ink droplets to a modeling part or support layer in an apparatus for modeling a three-dimensional object capable of modeling a colored three-dimensional object. More specifically, for example, the inventors considered using at least a part of inkjet heads for colored ink as the head for modeling material or head for support material, too, when modeling a three-dimensional object for which the coloring is not required, in an apparatus for modeling a three-dimensional object capable of modeling a colored three-dimensional object. Also, in this case, even when coloring a three-dimensional object, the inkjet heads for colored ink may also be enabled to discharge the ink droplets to a part of the modeling part or support layer, as required. In this way, it is possible to appropriately increase the modeling speed of the three-dimensional object without enlarging the apparatus and increasing the cost beyond necessity. That is, the present disclosure has following configurations so as to solve the above problem.

(Configuration 1) There is provided an apparatus for modeling a three-dimensional object configured to use a curable resin and to model a three-dimensional object by a lamination modeling method, the curable resin being a resin that is cured depending on a predetermined condition. The apparatus includes a plurality of heads for colored inks including the curable resin and configured to discharge ink droplets of colored inks having different colors from each other by an inkjet method; a curing unit configured to cure the curable resin, and a control unit configured to control operations of the plurality of heads for colored inks and the curing unit. When coloring at least a surface of the three-dimensional object on the basis of an image prepared in advance, the control unit enables the plurality of heads for colored inks to discharge the ink droplets, based on the image, to at least an outer periphery area of the three-dimensional object, which is an area of which a color is capable of being visibly recognized from an outside of the three-dimensional object, and at least when not coloring the surface of the three-dimensional object on the basis of the image, the control unit enables at least one of the heads for colored inks to discharge the ink droplets to an inner area, which is an area positioned at an inner side of the outer periphery area.

According to the above configuration, it is possible to appropriately color a three-dimensional object by the multiple heads for colored inks when modeling a colored three-dimensional object. Also, for example, when modeling a three-dimensional object for which the coloring is not required, it is possible to appropriately increase the modeling speed by using the head for coloring for modeling of the inner area. Also, in this case, the head for coloring is necessarily required to model the colored three-dimensional object. For this reason, it is not necessary to add a new inkjet head just for increasing the speed. For this reason, according to the above configuration, it is possible to appropriately increase the modeling speed of the three-dimensional object without enlarging the apparatus and increasing the cost beyond necessity.

Meanwhile, in the above configuration, the ink is liquid that is to be discharged from an inkjet head, for example. Also, the inkjet head is a liquid discharging head configured to discharge the liquid by an inkjet method. The inkjet method is a method of driving a driving element such as a piezo element to discharge the ink droplets from nozzles. Also, the apparatus for modeling a three-dimensional object may further have a head for modeling material configured to discharge ink droplets of modeling ink of the three-dimensional object, a head for support material configured to discharge ink droplets of ink becoming a material of a support layer, and the like.

Also, the head for colored ink is configured to discharge the ink droplets to positions designated from the control unit by performing a main scanning operation of discharging the ink droplets while moving in a preset main scanning direction. Also, when modeling a colored three-dimensional object, the control unit is configured to enable the head for colored ink to discharge the ink droplets by a multipath method. In this case, the multipath method is an operation of discharging the ink droplets to some spotting positions, which are designated by preset mask data, during each main scanning operation. By this configuration, it is possible to more appropriately perform the coloring of the three-dimensional object with high precision, for example. Also, when modeling a three-dimensional object for which the coloring is not required, the control unit enables each inkjet head to discharge the ink droplets by one path for each layer. By this configuration, it is possible to increase the modeling speed more appropriately, as compared to a configuration of discharging the ink droplets by the multipath method.

(Configuration 2) The curable resin is an ultraviolet curable resin that is cured by ultraviolet irradiation, and the curing unit is an ultraviolet light source configured to generate ultraviolet for curing the ultraviolet curable resin. By this configuration, it is possible to perform the modeling of the three-dimensional object more appropriately.

(Configuration 3) Even when coloring the surface of the three-dimensional object on the basis of the image, the control unit enables at least one of the heads for colored inks to discharge the ink droplets to the inner area. By this configuration, even when modeling a colored three-dimensional object, for example, it is possible to more appropriately increase the modeling speed.

(Configuration 4) Inkjet heads for respective colors of process colors are provided as the plurality of heads for colored inks, and at least one of the heads for colored inks configured to discharge the ink droplets to the inner area is an inkjet head for any one color of the process colors. By this configuration, it is possible to appropriately increase the modeling speed.

(Configuration 5) When not coloring the surface of the three-dimensional object on the basis of the image, the control unit controls operations of the plurality of heads for colored inks so that a color of the outer periphery area becomes a color within a preset range.

When performing the modeling by using the heads for colored ink, a color of a three-dimensional object to be modeled is influenced by the color of the colored ink. For this reason, even when modeling a three-dimensional object for which the coloring is not required, if the modeling is performed using the head for colored ink, the three-dimensional object is colored.

However, in this case, if a color of a surface of the three-dimensional object is too non-uniform, for example, an impression on an outward appearance of the three-dimensional object may be deteriorated. In particular, when the coloring is not performed after the modeling, an impression on an outward appearance of a final product may be deteriorated.

However, according to the above configuration, even when modeling a three-dimensional object for which the coloring is not required, it is possible to make the color of the surface of the three-dimensional object uniform in a certain extent of range. Also, thereby, it is possible to appropriately prevent an impression on an outward appearance of the three-dimensional object from being deteriorated.

In the meantime, the description “a color of the outer periphery area becomes a color within a preset range” means that a color of the surface of the three-dimensional object becomes a color within a predetermined range, for example. Also, more specifically, the description “a color of the surface of the three-dimensional object becomes a color within a predetermined range” means that a mixing ratio of colors as regards the inks of the respective colors of the process colors is within a predetermined range in the vicinity of the surface, for example.

(Configuration 6) A head for achromatic ink configured to discharge ink droplets of achromatic ink by the inkjet method is further provided, and at least when not coloring the surface of the three-dimensional object on the basis of the image, the control unit enables the head for achromatic ink to discharge the ink droplets to at least the inner area. By this configuration, it is possible to more appropriately increase the modeling speed, for example.

(Configuration 7) the achromatic ink is white ink, or transparent ink. By this configuration, it is possible to appropriately increase the modeling speed, for example.

(Configuration 8) The achromatic ink is transparent ink, and when coloring the surface of the three-dimensional object on the basis of the image, the control unit enables the head for achromatic ink to discharge the ink droplets to at least a coloring area of the outer periphery area.

When coloring the three-dimensional object, the ink droplets of the respective colors of the process colors are discharged with a ratio of colors to be colored at each position of the outer periphery area becoming a coloring target. In this case, when the outer periphery area is formed with only the color inks, for example, there are concerns that an ink amount per volume may be different due to the colors of the respective positions.

Regarding this, according to the above configuration, the ink droplets of the transparent ink can be discharged so as to supplement an ink amount per volume at each position of the outer periphery area. For this reason, by this configuration, it is possible to make a total volume of the color inks and the transparent ink substantially constant at each position of the outer periphery area, for example. Also, by this configuration, it is possible to model and color the three-dimensional object with higher precision, for example.

(Configuration 9) A head for modeling material configured to discharge ink droplets of ink for modeling the three-dimensional object and having a color different from the plurality of heads of colored inks by the inkjet method is further provided, and at least when not coloring the surface of the three-dimensional object on the basis of the image, the control unit enables at least one of the heads for colored inks and the head for modeling material to discharge the ink droplets to the inner area. By this configuration, it is possible to more appropriately increase the modeling speed, for example.

In the meantime, the modeling ink may be dedicated ink for modeling, for example. Also, as the modeling ink, it may also be considered to use the white ink, the transparent ink or the like, for example.

(Configuration 10) A mounting table configured to place the three-dimensional object being modeled on an upper surface thereof is further provided, and the control unit is configured to enable at least one of the heads for colored inks and the head for modeling material to discharge the ink droplets towards the mounting table, thereby forming respective ink layers configuring the inner area. By this configuration, it is possible to appropriately form the respective layers configuring the inner area by mixing the colored ink with the modeling ink and discharging the same.

(Configuration 11) A head for support material configured to discharge ink droplets, which become a material of a support layer configured to surround an outer periphery of the three-dimensional object being modeled and to support the three-dimensional object, by the inkjet method, is further provided, the control unit is configured to enable the head for support material to discharge the ink droplets to an area in which the support layer is to be formed, and at least when not coloring the surface of the three-dimensional object on the basis of the image, the control unit also enables at least one of the heads for colored inks to discharge the ink droplets to the area in which the support layer is to be formed.

By this configuration, it is possible to appropriately form the support layer, too, at higher speed. For this reason, by this configuration, it is possible to more appropriately increase the modeling speed, for example.

In the meantime, the material of the support layer is ink that is a water-soluble material, which can be dissolved by water, for example, and includes an ultraviolet curable resin. Since the support layer is removed after the modeling, a material of which a cure degree by the ultraviolet is lower than the modeled object is preferably used. The material of the support layer is also easily dissolved and removed by water, for example, after the modeling of the three-dimensional object is completed. For this reason, the heads for colored inks are configured to discharge the ink droplets with a density within a range in which the support layer is appropriately removed to the area in which the support layer is to be formed. More specifically, the heads for colored inks are configured to discharge the ink droplets with a density within a range in which the support layer is not strongly solidified as the colored ink is cured, for example. By this configuration, it is possible to appropriately increase the forming speed of the support layer, for example.

(Configuration 12) The head for support material and at least one of the heads for colored inks are configured to discharge ink droplets of inks having different properties to the area in which the support layer is to be formed. In this case, the property is a color, hardness, elasticity, strength and the like. Also, in this case, at least one of the hardness, the elasticity and the strength as the property is preferably made to be different.

By this configuration, for example, regarding the composition of the support layer, it is possible to variously change the property of the support layer by adjusting a ratio between the ink (material of the support layer) to be discharged from the head for support material and the inks (colored ink) to be discharged from the heads for colored inks. Also, thereby, it is possible to form the support layer having a desired property more appropriately, for example.

(Configuration 13) A mounting table configured to place the three-dimensional object being modeled on an upper surface thereof is further provided, and the head for support material and at least one of the heads for colored inks are configured to discharge ink droplets of inks having different adhesion strengths to the mounting table to the area in which the support layer is to be formed. By this configuration, it is possible to appropriately control adhesiveness of the support layer to the mounting table, for example.

Here, as the material of the support layer to be discharged from the head for support material, it is considered to use a material having high adhesiveness to the mounting table so as to securely support the three-dimensional object being modeled by the support layer. In this case, however, there are concerns that if the adhesiveness of the support layer to the mounting table is excessively high, it may be difficult to detach the three-dimensional object from the mounting table after the completion of the modeling. Also, the force is applied beyond necessity upon the detachment, so that the three-dimensional object may be damaged.

Regarding this, when forming the support layer by further using the colored ink having adhesiveness different from the material of the support layer, it is possible to adjust the adhesiveness of the support layer to the mounting table within an appropriate range by adjusting a ratio of both the inks in the support layer. Also, thereby, it is possible to more easily detach the three-dimensional object from the mounting table.

In the meantime, in this case, for example, it is considered to use ink having lower adhesiveness to the mounting table than the material of the support layer as the colored ink. Also, in this configuration, the mounting table is a table-shaped member (modeling platen) arranged at a position facing the heads for colored inks and the head for support material, for example. Also, when modeling the three-dimensional object, it may also be considered to place a plate (for example, resin plate), a sheet and the like on the mounting table and then to model the three-dimensional object thereon. In this case, the adhesion strength to the mounting table may be adhesion strength to the plate, the sheet and the like placed on the mounting table.

(Configuration 14) The control unit is configured to enable at least one of the heads for colored inks to discharge the ink droplets to the area in which the support layer is to be formed at least upon formation of an ink layer of the support layer closest to the mounting table. The ink layer closest to the mounting table is a lowest ink layer that is first formed on the mounting table, for example.

By this configuration, for example, it is possible to appropriately form the lowest ink layer of the support layer contacting the mounting table and the like by using the head for support material and the heads for colored inks. Also, thereby, it is possible to more appropriately adjust the adhesiveness of the support layer to the mounting table.

(Configuration 15) A mounting table configured to place the three-dimensional object being modeled on an upper surface thereon is further provided, and the control unit is configured to enable at least one of the heads for colored inks and the head for support material to discharge the ink droplets towards the mounting table, thereby forming respective ink layers configuring the support layer. By this configuration, for example, it is possible to appropriately form the respective layers configuring the support layer by mixing the colored ink with the material of the support layer to be discharged from the head for support material and discharging the same.

(Configuration 16) The control unit is configured to enable at least one of the heads for colored inks to discharge the ink droplets to the area in which the support layer is to be formed, thereby forming a pillar-shaped body, which is formed as the colored inks overlap with each other, in the support layer.

By this configuration, it is possible to form the support layer with a pillar-shaped body (pillar) formed of the colored ink being formed therein, for example. Also, thereby, for example, it is possible to form the stronger support layer supported with the pillar-shaped body. Also, in this case, a part except for the pillar-shaped body is filled with the material of the support layer, which is discharged from the head for support material and can be easily removed. For this reason, the pillar-shaped body is formed, so that the support layer can be easily removed. Therefore, by this configuration, it is possible to more appropriately form the support layer, which has the strong configuration capable of more securely supporting the three-dimensional object being modeled and can be easily removed.

In the meantime, the control unit is preferably configured to enable at least one of the heads for colored inks to form a plurality of pillar-shaped bodies side by side at a constant interval, for example. Also, in addition to the pillar-shaped bodies, areas connecting the multiple pillar-shaped bodies may be formed of the colored ink, and the parts of the colored ink in the support layer may be formed into a mesh shape. In this case, it is considered to form film-shaped areas connecting the multiple pillar-shaped bodies by the colored ink, in addition to the multiple pillar-shaped bodies. By this configuration, it is possible to form the stronger support layer, for example.

(Configuration 17) There is provided a method for modeling a three-dimensional object configured to use a curable resin and to model a three-dimensional object by a lamination modeling method, the curable resin being a resin that is cured depending on a predetermined condition. The method uses a plurality of heads for colored inks including the curable resin and configured to discharge ink droplets of colored inks having different colors from each other by an inkjet method, and a curing unit configured to cure the curable resin. The method includes: controlling operations of the plurality of heads for colored inks and the curing unit, when coloring at least a surface of the three-dimensional object on the basis of an image prepared in advance, enabling the plurality of heads for colored inks to discharge the ink droplets, based on the image, to at least an outer periphery area of the three-dimensional object, which is an area of which a color is capable of being visibly recognized from an outside of the three-dimensional object, and at least when not coloring the surface of the three-dimensional object on the basis of the image, enabling at least one of the heads for colored inks to discharge the ink droplets to an inner area, which is an area positioned at an inner side of the outer periphery area. By this configuration, it is possible to accomplish the same effects as the configuration 1, for example.

(Configuration 18) There is provided an apparatus for modeling a three-dimensional object configured to use a curable resin and to model a three-dimensional object by a lamination modeling method, the curable resin being a resin that is cured depending on a predetermined condition. The apparatus includes a plurality of heads for colored inks including the curable resin and configured to discharge ink droplets of colored inks having different colors from each other by an inkjet method; a curing unit configured to cure the curable resin; a head for support material configured to discharge ink droplets, which become a material of a support layer configured to surround an outer periphery of the three-dimensional object being modeled and to support the three-dimensional object, by the inkjet method, and a control unit configured to control operations of the plurality of heads for colored inks, the curing unit and the head for support material. The control unit is configured to enable the head for support material to discharge the ink droplets to an area in which the support layer is to be formed, and at least when not coloring a surface of the three-dimensional object on the basis of an image prepared in advance, the control unit enables at least one of the heads for colored inks to discharge the ink droplets to the area in which the support layer is to be formed.

By this configuration, it is possible to appropriately increase the forming speed of the support layer, for example. Also, thereby, it is possible to appropriately increase the modeling speed of the three-dimensional object. Meanwhile, in this case, for example, the support layer may be formed in accordance with the configurations 12 to 16, for example. By this configuration, it is possible to accomplish the same effects as the configurations 12 to 16, for example. Also, even when coloring a surface of the three-dimensional object, the heads for colored inks may discharge the ink droplets to an area, in which the support layer is to be formed, in accordance with an instruction of the control unit.

(Configuration 19) There is provided a method for modeling a three-dimensional object configured to use a curable resin and to model a three-dimensional object by a lamination modeling method, the curable resin being a resin that is cured depending on a predetermined condition. The method uses a plurality of heads for colored inks including the curable resin and configured to discharge ink droplets of colored inks having different colors from each other by an inkjet method, a curing unit configured to cure the curable resin, and a head for support material configured to discharge ink droplets, which become a material of a support layer configured to surround an outer periphery of the three-dimensional object being modeled and to support the three-dimensional object, by the inkjet method. The method includes: controlling operations of the plurality of heads for colored inks, the curing unit and the head for support material, enabling the head for support material to discharge the ink droplets to an area in which the support layer is to be formed, and at least when not coloring a surface of the three-dimensional object on the basis of an image prepared in advance, enabling at least one of the heads for colored inks to discharge the ink droplets to the area in which the support layer is to be formed. By this configuration, it is possible to accomplish the same effects as the configuration 18, for example.

According to the present disclosure, it is possible to appropriately increase the modeling speed of the three-dimensional object, for example.

### BRIEF DESCRIPTION OF THE DRAWINGS

FIGS. 1A and 1B illustrate an example of an apparatus 10 for modeling a three-dimensional object according to an illustrative embodiment of the present disclosure, in which FIG. 1A illustrates an example of a configuration of main parts of the apparatus 10 for modeling a three-dimensional object, and

FIG. 1B illustrates an example of a three-dimensional object 5 that is to be modeled by the apparatus 10 for modeling a three-dimensional object.

FIG. 2 illustrates in detail an example of a configuration of a discharge unit 12.

FIGS. 3A and 3B are pictorial views illustrating an example of a configuration of the three-dimensional object 5 that is to be modeled by a coloring modeling operation, in which FIG. 3A illustrates an example of a vertical section of the three-dimensional object 5 and FIG. 3B illustrates an example of a horizontal section of the three-dimensional object 5.

FIGS. 4A and 4B illustrate in detail a main scanning operation that is to be performed in the illustrative embodiment, in which FIG. 4A illustrates an example of a pattern of the main scanning operation in a forward direction, and FIG. 4B illustrates an example of a pattern of the main scanning operation in a backward direction.

FIGS. 5A to 5C illustrate examples of more specific patterns of a 5a(n) layer and a 5a(n+1) layer, which are ink layers, when performing the coloring modeling operation, in which FIG. 5A is a pictorial view illustrating an example of a pattern upon formation of the 5a(n) layer, FIG. 5B is a pictorial view illustrating an example of a pattern upon formation of the 5a(n+1) layer, and FIG. 5C illustrates an example of an actual arranging method as regards an arranging method of ink dots that are to be formed by the main scanning operation in the backward direction.

FIGS. 6A and 6B illustrate in detail an example of a configuration of each area that is to be formed by the coloring modeling operation, in which FIGS. 6A and 6B illustrate in detail examples of the configurations of the 5a(n) layer and the 5a(n+1) layer shown in FIGS. 5A and 5B.

FIG. 7 is a vertical sectional view of the three-dimensional object 5 being modeled and a support 6.

FIGS. 8A to 8C illustrate a pattern for forming a support material area 402 and a coloring ink area 404, in which FIGS. 8A to 8C illustrate examples of the pattern for forming the support material area 402 and the coloring ink area 404.

FIGS. 9A and 9B illustrate a configuration of the support 6 when forming a pillar-shaped body of colored ink, in which FIG. 9A illustrates an example of the configuration of the support 6 and FIG. 9B illustrates another example of the configuration of the support 6.

### DETAILED DESCRIPTION OF THE EMBODIMENTS

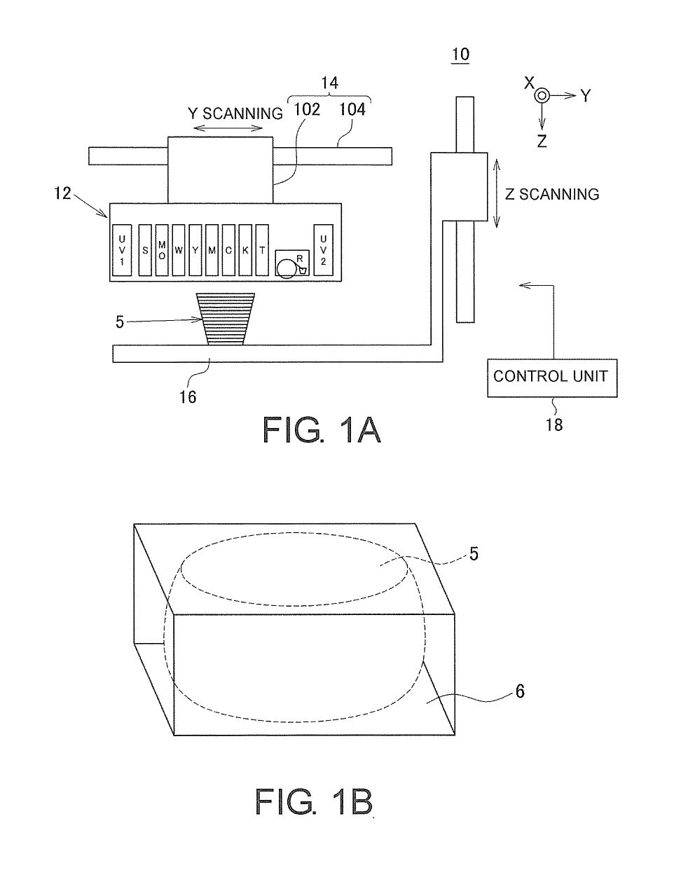

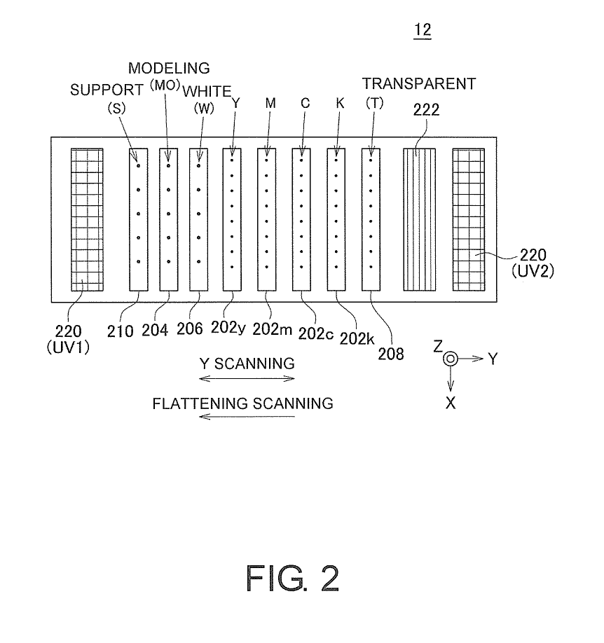

Hereinafter, an illustrative embodiment of the present disclosure will be described with reference to the drawings. FIGS. 1A and 1B illustrate an example of an apparatus 10 for modeling a three-dimensional object according to an illustrative embodiment of the present disclosure. FIG. 1A illustrates an example of a configuration of main parts of the apparatus 10 for modeling a three-dimensional object, and FIG. 1B illustrates an example of a three-dimensional object 5 that is to be modeled by the apparatus 10 for modeling a three-dimensional object.

In this illustrative embodiment, the apparatus 10 for modeling a three-dimensional object is an apparatus for modeling the three-dimensional object 5 by a lamination modeling method. In this case, the lamination modeling method is a method of overlapping a plurality of layers to model the three-dimensional object 5. Also, the three-dimensional object 5 is a three-dimensional structure, for example.

Also, in this illustrative embodiment, the apparatus 10 for modeling a three-dimensional object is configured to perform an operation (hereinafter, referred to as coloring modeling operation) of coloring at least a surface of a three-dimensional object on the basis of an image prepared in advance and an operation (hereinafter, referred to as non-coloring modeling operation) of not coloring a surface of a three-dimensional object on the basis of the image, as an operation of modeling the three-dimensional object 5, in accordance with data indicating the three-dimensional object 5 to be modeled. In this case, the coloring modeling operation is an operation of modeling a colored three-dimensional structure by using shape information of the three-dimensional structure and color image information, for example. Also, the non-coloring modeling operation is a modeling operation only by using the shape information of the three-dimensional structure of the shape information of the three-dimensional structure and the color image information, without using the color image information. The non-coloring modeling operation may be an operation of modeling a three-dimensional structure for which the coloring is not required. The coloring modeling operation and the non-coloring modeling operation will be described in more detail later.

Also, the apparatus 10 for modeling a three-dimensional object may have the same or equivalent configuration as or to a well-known apparatus for modeling a three-dimensional object, except for a configuration that will be described later. Also, the apparatus 10 for modeling a three-dimensional object may be an apparatus implemented by changing a part of a configuration of a well-known inkjet printer. For example, the apparatus 10 for modeling a three-dimensional object may be an apparatus implemented by changing a part of an inkjet printer for printing a two-dimensional image, which uses ultraviolet curable ink (UV ink).

In this illustrative embodiment, the apparatus 10 for modeling a three-dimensional object has a discharge unit 12, a main scanning driving unit 14, a modeling platen 16 and a control unit 18. The discharge unit 12 is a part configured to discharge droplets (ink droplets) becoming a material of the three-dimensional object 5, and is configured to discharge ink droplets and the like of a curable resin, which is a resin to be cured depending on a predetermined condition, and to form each layer configuring the three-dimensional object 5 by curing the ink droplets. More specifically, in this illustrative embodiment, the discharge unit 12 is configured to repeatedly execute several times a layer forming operation of discharging the ink droplets to form a layer of the curable resin in accordance with an instruction of the control unit 18, and a curing operation of curing the layer of the curable resin formed by the layer forming operation. Thereby, the discharge unit 12 overlaps and forms a plurality of cured layers of the curable resin.

Also, in this illustrative embodiment, an ultraviolet curable resin, which is cured by ultraviolet irradiation, is used as the curable resin. In this case, the discharge unit 12 is configured to discharge the ink droplets of the ultraviolet curable ink, for example, as the ink droplets becoming the material of the three-dimensional object 5. Also, in the curing operation, the discharge unit is configured to irradiate the ultraviolet by an ultraviolet light source, thereby curing the layer of the curable resin. In this case, the layer of the curable resin is a layer of the ultraviolet curable ink.

Also, in this illustrative embodiment, when performing the coloring modeling operation, the discharge unit 12 discharges the ink droplets of colored ultraviolet curable ink, thereby coloring a surface of the three-dimensional object 5. Thereby, the colored three-dimensional object 5 is modeled. Further, in this illustrative embodiment, the discharge unit 12 is configured to form a support 6 around the three-dimensional object 5 upon the modeling of the three-dimensional object 5, as shown in FIG. 1B. The support 6 is a laminated structure (support layer) configured to support the three-dimensional object 5 by surrounding a periphery of the three-dimensional object 5 being modeled. The support 6 is dissolved and removed by water, for example, after the modeling of the three-dimensional object 5 is completed. In the meantime, the more specific configuration and operation of the discharge unit 12 will be described in more detail later.

The main scanning driving unit 14 is a driving unit for enabling the discharge unit 12 to perform the main scanning operation. In this case, the configuration of enabling the discharge unit 12 to perform the main scanning operation is to enable inkjet heads of the discharge unit 12 to perform the main scanning operation. Also, the main scanning operation is an operation of discharging the ink droplets while moving in a preset main scanning direction (Y direction in the drawings), for example.

In this illustrative embodiment, the main scanning driving unit 14 has a carriage 102 and a guide rail 104. The carriage 102 is a holding unit configured to hold the discharge unit 12 with facing the modeling platen 16. In this case, the configuration of holding the discharge unit 12 with facing the modeling platen 16 is to hold the discharge unit 12 so that a discharge direction of the ink droplets faces towards the modeling platen 16. Also, during the main scanning operation, the carriage 102 moves along the guide rail 104 with holding the discharge unit 12. The guide rail 104 is a rail-shaped member configured to guide the movement of the carriage 102, and moves the carriage 102 in response to an instruction of the control unit 18 during the main scanning operation.

In the meantime, the movement of the discharge unit 12 during the main scanning operation may be a relative movement to the three-dimensional object 5. For this reason, in a modified embodiment of the configuration of the apparatus 10 for modeling a three-dimensional object, a position of the discharge unit 12 may be fixed and the modeling platen 16 may be moved to move the three-dimensional object 5, for example.

The modeling platen 16 is an example of the mounting table, and is configured to place the three-dimensional object 5 being modeled on an upper surface thereon. In this illustrative embodiment, the modeling platen 16 has a function of moving the upper surface in a vertical direction (Z direction in the drawings), and is configured to move the upper surface in conformity to progressing of the modeling of the three-dimensional object 5, in response to an instruction of the control unit 18. Thereby, it is possible to appropriately adjust a distance (gap) between a surface to be modeled of the three-dimensional object 5 being modeled and the discharge unit 12. In this case, the surface to be modeled of the three-dimensional object 5 is a surface on which a next layer is to be formed by the discharge unit 12, for example. In the meantime, the scanning in the Z direction of vertically moving the modeling platen 16 relative to the discharge unit 12 may be performed by moving the discharge unit 12.

The control unit 18 is a CPU of the apparatus 10 for modeling a three-dimensional object, for example, and is configured to control the respective units of the apparatus 10 for modeling a three-dimensional object on the basis of the shape information of the three-dimensional object 5 to be modeled, the color image information and the like, thereby controlling operations for modeling the three-dimensional object 5. According to this illustrative embodiment, it is possible to appropriately model the three-dimensional object 5.

In the meantime, the apparatus 10 for modeling a three-dimensional object may further have a variety of configurations necessary for the modeling, the coloring and the like of the three-dimensional object 5, for example, in addition to the configuration shown in FIG. 1A. For instance, the apparatus 10 for modeling a three-dimensional object may further have a sub-scanning driving unit for enabling the discharge unit 12 to perform a sub-scanning operation. In this case, the sub-scanning operation is an operation of moving the inkjet heads of the discharge unit 12 relative to the three-dimensional object 5 being modeled, in a sub-scanning direction (X direction in the drawings) orthogonal to the main scanning direction. For example, the sub-scanning driving unit enables the discharge unit 12 to perform the sub-scanning operation, if required, when modeling the three-dimensional object 5 of which a length in the sub-scanning direction is longer than a modeling width of the inkjet heads of the discharge unit 12. More specifically, the sub-scanning driving unit may be a driving unit configured to move the modeling platen 16 in the sub-scanning direction, for example. Also, the sub-scanning driving unit may be a driving unit configured to move the guide rail 104 together with the carriage 102 configured to hold the discharge unit 12 in the sub-scanning direction, for example.

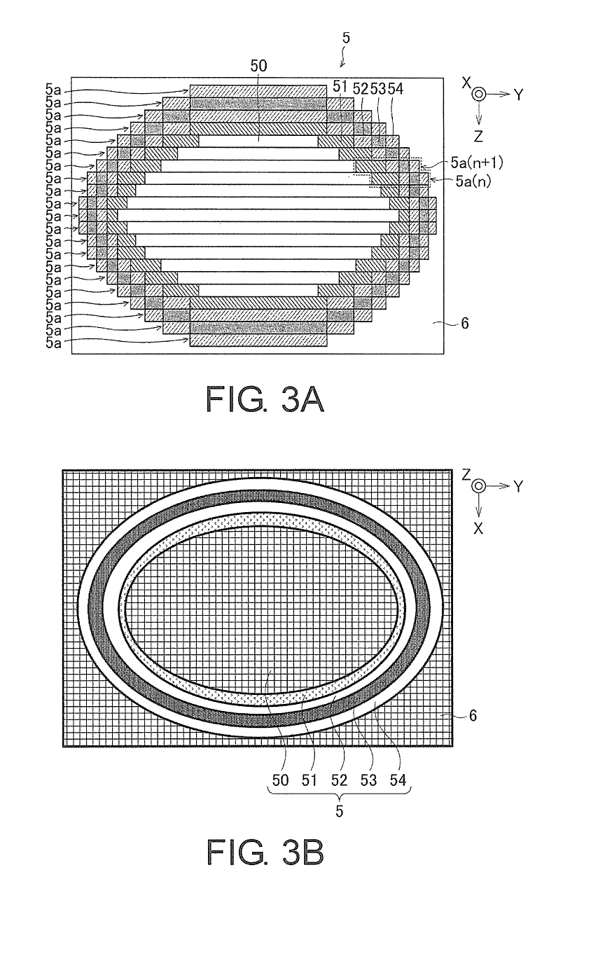

Subsequently, the more specific configuration and operation of the discharge unit 12 are described. FIG. 2 illustrates in detail an example of the configuration of the discharge unit 12. In this illustrative embodiment, the discharge unit 12 has a plurality of heads 202y, 202m, 202c, 202k for colored inks (hereinafter, referred to as heads 202y to 202k for colored inks), a head 206 for white ink, a head 208 for transparent ink, a head 204 for modeling material, a head 210 for support material, a plurality of ultraviolet light sources 220 and a flattening roller unit 222.

The heads 202y to 202k for colored inks, the head 206 for white ink, the head 208 for transparent ink, the head 210 for support material and the head 204 for modeling material are examples of the discharge head configured to discharge ink droplets of a curable resin by an inkjet method. Also, in this illustrative embodiment, the heads 202y to 202k for colored inks, the head 206 for white ink, the head 208 for transparent ink, the head 210 for support material and the head 204 for modeling material are inkjet heads configured to discharge ink droplets of ultraviolet curable ink, for example, and are disposed side by side in the main scanning direction (Y direction) with positions thereof being aligned in the sub-scanning direction (X direction).

The heads 202y to 202k for colored inks are inkjet heads configured to discharge ink droplets of colored inks having different colors, respectively. In this illustrative embodiment, the heads 202y to 202k for colored inks are configured to discharge ink droplets of ultraviolet curable inks of respective colors of YMCK. The head 206 for white ink is an inkjet head configured to discharge ink droplets of white (W) ultraviolet curable ink.

Also, the head 208 for transparent ink is an inkjet head configured to discharge ink droplets of ultraviolet curable transparent ink. In this case, the transparent (T) ink is colorless transparent ink or colored transparent ink. The colorless transparent ink may be ink that includes an ultraviolet curable ink but does not include colorant. The colored transparent ink may be ink that includes an ultraviolet curable ink and include colorant.

Meanwhile, in this illustrative embodiment, the respective colors of YMCK are examples of respective colors of process colors. Also, the discharge unit 12 may further have an inkjet head for a color such as flame color of each color, red (R), green (G), blue (B), orange and the like. Also, the white ink and the transparent ink are examples of the achromatic ink. Also, the heads 202y to 202k for colored inks are examples of the inkjet heads for respective colors of the process colors. The head 206 for white ink and the head 208 for transparent ink are examples of the head for achromatic ink.

The head 204 for modeling material is an inkjet head configured to discharge ink droplets of ultraviolet curable ink to be used for modeling an inside of the three-dimensional object 5. In this illustrative embodiment, the head 204 for modeling material is configured to discharge ink droplets of modeling ink (modeling material MO) of a predetermined color. The modeling ink may be dedicated ink for modeling, for example. Also, in this illustrative embodiment, the modeling ink is ink of a color different from the respective colors of YMCK. As the modeling ink, the white ink, the transparent ink or the like may also be used, for example.

The head 210 for support material is an inkjet head configured to discharge ink droplets including a material (support material S) of the support 6 (refer to FIGS. 1A and 1B). In this illustrative embodiment, as the material of the support 6, a water-soluble material, which can be dissolved by water after the modeling of the three-dimensional object 5, is preferably used. Also, since the material of the support 6 is removed after the modeling, a material of which a cure degree by the ultraviolet is lower than the modeled object and which is likely to be dissolved is preferably used. In this way, it is possible to perform the modeling using the support 6 more appropriately. As the material of the support 6, a well-known material for the support 6 may be suitably used, for example. Also, in this illustrative embodiment, the head 210 for support material is arranged side by side with respect to the heads 202y to 202k for colored inks, the head 206 for white ink, the head 208 for transparent ink and the head 204 for modeling material in the main scanning direction with a position thereof being aligned in the sub-scanning direction.

In the meantime, the well-known inkjet heads, for example, can be appropriately used as the heads 202y to 202k for colored inks, the head 206 for white ink, the head 208 for transparent ink, the head 204 for modeling material and the head 210 for support material. Also, each of the inkjet heads has a nozzle line of which a plurality of nozzles is aligned side by side in the sub-scanning direction, on a surface facing the modeling platen 16 (refer to FIGS. 1A and 1B). In this case, the nozzle lines of the respective inkjet heads are the same as regards the aligning direction and are parallel with each other. Also, during the main scanning operation, the inkjet heads discharge the ink droplets in the Z direction while moving in the main scanning direction orthogonal to the aligning direction of the nozzles.

The multiple ultraviolet light sources 220 are ultraviolet light sources configured to cure the ultraviolet curable ink, and ultraviolet LEDs, metal halide lamps, mercury lamps and the like are used. Also, in this illustrative embodiment, the multiple ultraviolet light sources 220 are examples of the curing unit configured to cure the curable resin. The ultraviolet light sources 220 are respectively positioned at one end-side and at the other end-side of the discharge unit 12 in the main scanning direction so that the heads 202y to 202k for colored inks, the head 204 for modeling material, the head 206 for white ink, the head 208 for transparent ink and the head 210 for support material are positioned therebetween. More specifically, for example, the one ultraviolet light source 220 denoted with a reference numeral UV1 in the drawings is arranged at the one end-side of the discharge unit 12. Also, the other ultraviolet light source 220 denoted with a reference numeral UV2 in the drawings is arranged at the other end-side of the discharge unit 12.

The flattening roller unit 222 is configured to flatten a layer of ultraviolet curable ink, which is formed during the modeling of the three-dimensional object 5. In this illustrative embodiment, the flattening roller unit 222 is arranged between the arrangement of the heads 202y to 202k for colored inks, the head 204 for modeling material, the head 206 for white ink, the head 208 for transparent ink and the head 210 for support material and the other ultraviolet light source 220 (UV2). Thereby, the flattening roller unit 222 is arranged side by side with respect to the arrangement of the heads 202y to 202k for colored inks, the head 204 for modeling material, the head 206 for white ink, the head 208 for transparent ink and the head 210 for support material in the main scanning direction with a position thereof being aligned in the sub-scanning direction.

By the above configuration, the discharge unit 12 is configured to perform an operation of modeling the three-dimensional object 5, in response to an instruction of the control unit 18 (refer to FIGS. 1A and 1B). Also, when performing the coloring modeling operation, the discharge unit 12 further performs an operation of coloring a surface of the three-dimensional object 5. Also, regarding the operations, the discharge unit 12 repeats the layer forming operation and the curing operation, as described above with reference to FIGS. 1A and 1B.

Also, in this illustrative embodiment, more specifically, the discharge unit 12 is configured to perform a discharge operation and a flattening operation during the layer forming operation. In this case, the discharge operation is an operation of enabling each inkjet head of the discharge unit 12 to discharge the ink droplets of the ultraviolet curable ink, thereby applying the ink to an area in which a layer of the ultraviolet curable ink is to be formed. Also, the flattening operation is an operation of flattening the layer of the ultraviolet curable ink applied in the discharge operation by using the flattening roller unit 222. The flattening operation may be an operation of flattening the ink layer while at least a part of operating times of the main scanning direction is being performed.

Meanwhile, as described above, in this illustrative embodiment, the inkjet head of the discharge unit 12 is configured to discharge the ink droplets to a position designated by the control unit 18 by performing the main scanning direction. Also, during the discharge operation, the inkjet heads are configured to perform the reciprocating main scanning operation in the main scanning direction, as shown with the arrow denoted with ‘Y scanning’ in the drawings, for example.

Also, during the main scanning operation of this illustrative embodiment, the flattening roller unit 222 is configured to move together with the inkjet heads of the discharge unit 12. However, as shown, in this illustrative embodiment, the flattening roller unit 222 is arranged only at one side of the inkjet heads with respect to the main scanning direction. For this reason, in this illustrative embodiment, the flattening operation is performed only during the one main scanning operation in a forward or backward direction, as shown with the arrow denoted with ‘flattening scanning’ in the drawings, for example. As can be seen from the drawings, the one main scanning operation is a main scanning operation in a direction in which the flattening roller unit 222 is located at the rear of the inkjet heads during the movement.

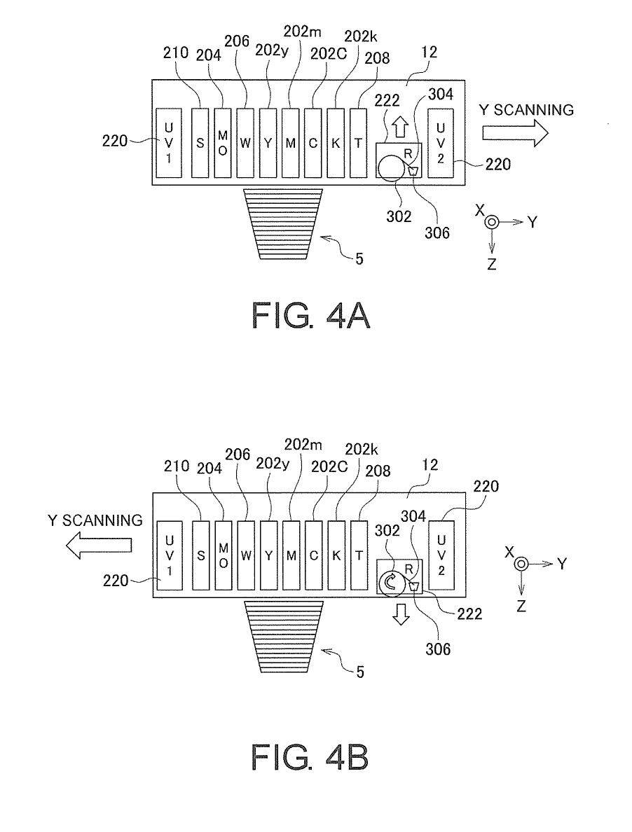

Subsequently, the more specific configuration of the three-dimensional object 5, which is to be modeled in the illustrative embodiment, is described. FIGS. 3A and 3B are pictorial views illustrating an example of the configuration of the three-dimensional object 5 that is to be modeled by the coloring modeling operation. FIG. 3A illustrates an example of a vertical section of the three-dimensional object 5 and FIG. 3B illustrates an example of a horizontal section of the three-dimensional object 5.

As described above, in this illustrative embodiment, the apparatus 10 for modeling a three-dimensional object is configured to overlap a plurality of layers of the ultraviolet curable ink, thereby modeling the three-dimensional object 5. More specifically, the apparatus is configured to overlap a plurality of layers denoted with a reference numeral 5a in FIG. 3A, thereby modeling the three-dimensional object 5, for example. Also, the apparatus is configured to form the support 6 around the three-dimensional object 5 by the head 210 for support material of the discharge unit 12.

Meanwhile, in this illustrative embodiment, the operation of forming the respective layers (layers 5a) configuring the three-dimensional object 5 will be described in more detail later, with reference to the layers denoted with reference numerals 5a(n) and 5a(n+1) in FIG. 3A. The layers denoted with the reference numerals 5a(n) and 5a(n+1) indicate a n^{th} layer and a (n+1)^{th} layer from below, for example.

Also, in this illustrative embodiment, the apparatus 10 for modeling a three-dimensional object is configured to form a layer having an inner area and an outer periphery area, as a layer of the ultraviolet curable ink, during the layer forming operation. In this case, the inner area is an area configuring an inside of the three-dimensional object 5. The outer periphery area is an area (outer area) of which a color can be visibly recognized from an outside of the three-dimensional object 5, for example. Also, in this illustrative embodiment, when performing the coloring modeling operation, the apparatus 10 for modeling a three-dimensional object forms an inner modeling area 50, an inner white area 51 and an inner transparent area 52, as the inner area. Also, the apparatus forms a coloring area 53 and an outer transparent area 54, as the outer periphery area.

In the meantime, although not shown, when performing the non-coloring modeling operation, the apparatus 10 for modeling a three-dimensional object forms only an area for modeling, for example, as the inner area and the outer periphery area. In this case, both the inner area and the outer periphery area may be areas having the same configuration as the inner modeling area 50, which is formed when performing the coloring modeling operation. Also, the same area as the outer transparent area 54 may be formed in the outer periphery area, as required. The non-coloring modeling operation will be described in more detail later. In the below, the coloring modeling operation is first described.

The inner modeling area 50 is an area (Mo layer) configuring the innermost part of the three-dimensional object 5, which is to be modeled by the coloring modeling operation. In this case, the innermost part of the three-dimensional object 5 is a part surrounded by the other areas (the inner white area 51, the inner transparent area 52, the coloring area 53 and the outer transparent area 54) in each layer that is to be formed during the layer forming operation, for example.

Also, when performing the coloring modeling operation, the apparatus 10 for modeling a three-dimensional object forms the inner modeling area 50 by using at least the head 204 for modeling material. Also, in this illustrative embodiment, the apparatus is configured to use the heads 202y to 202k for colored inks, the head 206 for white ink and the head 208 for transparent ink, in addition to the head 204 for modeling material, so as to model at least a part of the inner modeling area 50. Thereby, when performing the coloring modeling operation, the apparatus 10 for modeling a three-dimensional object forms at least a part of the inner modeling area 50 by the white ink, the transparent ink and the color ink. By this configuration, the inner modeling area 50 is formed using the plurality of inkjet heads, so that it is possible to complete the modeling of the three-dimensional object 5 in a shorter time, for example.

In the meantime, the inner modeling area 50 is an area functioning as a modeling layer configuring a basic part of a shape of the three-dimensional object 5. The inner modeling area 50 may be an area of which a part is void. Also, the inner modeling area 50 may be formed using only some inkjet heads of the head 204 for modeling material, the heads 202y to 202k for colored inks, the head 206 for white ink and the head 208 for transparent ink. For example, the control unit 18 (refer to FIGS. 1A and 1B) may be configured to enable at least one of the heads 202y to 202k for colored inks and the head 204 for modeling material to discharge the ink droplets to the inner modeling area 50. Also in this configuration, it is possible to appropriately increase the modeling speed of the three-dimensional object 5, as compared to a configuration where the inner modeling area 50 is formed using only the head 204 for modeling material, for example. Also, for example, the inner modeling area 50 may be formed using only one of the heads 202y to 202k for colored inks.

The inner white area 51 is a white layer area (W layer) configured to surround the periphery of the inner modeling area 50 in contact with the inner modeling area 50. Also, the inner white area 51 contacts the coloring area 53 with the inner transparent area 52 being interposed therebetween in an outer direction of the three-dimensional object 5. By this configuration, the inner white area 51 is configured to reflect light, which is incident from an outside of the three-dimensional object 5 through the coloring area 53. By this configuration, it is possible to implement a color expression by a subtractive color process for a color colored in the coloring area 53, for example. Also, by this configuration, it is possible to make a color colored in the coloring area 53 be visibly recognized as a more appropriate color from the outside of the three-dimensional object 5.

In this illustrative embodiment, the inner white area 51 is formed using the head 206 for white ink, for example. Also, the color of the inner white area 51 may be set to white or a color close to white within a range in which the color expression by the subtractive color process can be implemented.

The inner transparent area 52 is an area (T layer) configured to surround the inner modeling area 50 with the inner white area 51 being interposed therebetween, and contacts both the inner white area 51 and the coloring area 53 between the inner white area 51 positioned at an inner side and the coloring area 53 positioned at an outer side. Also, in this illustrative embodiment, the inner transparent area 52 is formed using the head 208 for transparent ink. The inner transparent area 52 is formed, so that it is possible to appropriately prevent the white ink of the inner white area 51 and the YMCK inks of the coloring area 53 from being mixed upon the flattening of the ink layer, for example. For this reason, by this configuration, it is possible to perform the flattening operation of the flattening roller unit 222 more appropriately, for example.

The coloring area 53 is an area (coloring layer) configured to surround the periphery of the inner modeling area 50 with the inner white area 51 and the inner transparent area 52 being interposed therebetween. Also, in this illustrative embodiment, the coloring area 53 configures an outer area of the three-dimensional object 5 of which a color can be visibly recognized from the outside of the three-dimensional object 5 through the outer transparent area 54. During the discharge operation, the apparatus 10 for modeling a three-dimensional object is configured to discharge the ink droplets of the YMCK inks to the coloring area 53 by the heads 202y to 202k for colored inks, thereby coloring the coloring area 53. In this case, the control unit 18 is configured to enable the heads 202y to 202k for colored inks to discharge the ink droplets on the basis of an image indicating the color image information, thereby enabling the heads 202y to 202k for colored inks to color the coloring area 53. Also, in this illustrative embodiment, the apparatus 10 for modeling a three-dimensional object is configured to further use, as the inkjet head configured to discharge the ink droplets to the coloring area 53, the head 208 for transparent ink, in addition to the heads 202y to 202k for colored inks. Thereby, the apparatus 10 for modeling a three-dimensional object forms the coloring area 53 by the YMCK inks and the transparent ink.

In the meantime, it is also considered to color only a part of the area, depending on the using applications of the three-dimensional object 5. In this case, the coloring area 53 may be formed only by the transparent ink for an area for which the coloring is not performed. Also, the coloring area 53 may be omitted for the part of the area.

The outer transparent area 54 is an area (T layer) configured to surround the periphery of the inner modeling area 50 with the inner white area 51, the inner transparent area 52 and the coloring area 53 being interposed therebetween, and configures the outermost surface of the three-dimensional object 5. In this illustrative embodiment, the outer transparent area 54 is formed using the head 208 for transparent ink. The outer transparent area 54 is formed, so that it is possible to appropriately protect the surface of the three-dimensional object 5 and to prevent the coloring area 53 from being discolored due to the ultraviolet of the natural light. Also, as can be clearly seen from the above description, according to the illustrative embodiment, it is possible to appropriately model and color the three-dimensional object 5 during the coloring modeling operation, for example.

Here, when coloring the coloring area 53, the ink droplets of the respective colors of YMCK, which are color inks, are discharged with a ratio of colors to be colored at each position of the coloring area 53. In this case, each position of the coloring area 53 indicates an area including a plurality of spotting positions (droplet attaching positions) close to each other. Also, the spotting position is a spotting position of the ink droplet to be discharged during the main scanning operation. In this case, when the coloring area 53 is formed with only the color inks, for example, there are concerns that an ink amount per volume may be different due to the colors of the respective positions.

Regarding this, in this illustrative embodiment, as described above, the coloring area 53 is formed using not only the color inks but also the color inks and the transparent ink. In this case, the head 208 for transparent ink is configured to discharge the ink droplets of the transparent ink to the coloring area 53 so as to supplement an ink amount per volume at each position of the coloring area 53. By this configuration, it is possible to make a total volume of the color inks and the transparent ink substantially constant at each position of the coloring area 53, for example. Also, by this configuration, it is possible to model and color the three-dimensional object 5 with higher precision. For this reason, according to this illustrative embodiment, when modeling the colored three-dimensional object 5, it is possible to more appropriately color the three-dimensional object 5 by the heads 202y to 202k for colored inks.

Also, as described above with reference to FIG. 1B and the like, according to the illustrative embodiment, the apparatus 10 for modeling a three-dimensional object is configured to form the support 6 (S layer) around the three-dimensional object 5. Also, the apparatus 10 for modeling a three-dimensional object is configured to form the support 6 by using at least the head 210 for support material. Also, in this illustrative embodiment, when performing the coloring modeling operation, the apparatus further uses the heads 202y to 202k for colored inks, the head 206 for white ink and the head 208 for transparent ink, in addition to the head 210 for support material, so as to model a part of the support 6. By this configuration, the apparatus 10 for modeling a three-dimensional object forms a part of the support 6 by using the white ink, the transparent ink and the color inks. By this configuration, the support 6 is formed using the plurality of inkjet heads, so that it is possible to model the three-dimensional object 5 in a shorter time, for example. Also, it is possible to appropriately increase the modeling speed of the three-dimensional object 5, for example.

In the meantime, when forming the support 6, the inkjet head to be used, except for the head 210 for support material, may be some of the heads 202y to 202k for colored inks, the head 206 for white ink and the head 208 for transparent ink. For example, the control unit 18 may be configured to enable at least one of the heads 202y to 202k for colored inks and the head 210 for support material to discharge the ink droplets to an area in which the support 6 is to be formed.

Also, in this illustrative embodiment, the support 6 is dissolved and removed by water, for example, after completing the modeling of the three-dimensional object 5. For this reason, when using the inkjet heads (the heads 202y to 202k for colored inks, and the like) except for the head 210 for support material upon the formation of the support 6, the corresponding inkjet head is enabled to discharge the ink droplets to an area, in which the support 6 is to be formed, with a density within a range in which the support 6 can be appropriately removed. More specifically, when using the support 6 by using the heads 202y to 202k for colored inks, in addition to the head 210 for support material, for example, the heads 202y to 202k for colored inks are enabled to discharge the ink droplets with a density within a range in which the support 6 is not solidified as the ink is cured, for example, a density of 20% to 90%, preferably 50% to 80% of the total.

Subsequently, operations that are performed when executing the non-coloring modeling operation are described. Meanwhile, in this illustrative embodiment, the operations that are performed when executing the non-coloring modeling operation are the same as or equivalent to the operations that are performed when executing the coloring modeling operation, except for the below description.

When performing the non-coloring modeling operation, it is not necessary to provide an area for coloring in the three-dimensional object 5. For this reason, in this case, it is not necessary to form the inner white area 51 and the coloring area 53, for example. Also, as a result, it is not necessary to form the inner transparent area 52 between the inner white area 51 and the coloring area 53.

For this reason, as described above, when performing the non-coloring modeling operation, the apparatus 10 for modeling a three-dimensional object forms only an area for modeling, for example, as the inner area and the outer periphery area. In this case, both the inner area and the outer periphery area may be areas having the same configuration as the inner modeling area 50, which is formed when performing the coloring modeling operation. Also, the same area as the outer transparent area 54 may be formed in the outer periphery area, as required.

Also, in this case, the apparatus 10 for modeling a three-dimensional object is configured to form the inner area, which is an area for modeling, by using the other inkjet heads, in addition to the head 204 for modeling material, like the formation of the inner modeling area 50 during the coloring modeling operation. For example, when performing the non-coloring modeling operation, the control unit 18 enables the head 204 for modeling material and at least one of the heads 202y to 202k for colored inks to discharge the ink droplets to the inner area. More specifically, for example, the heads 202y to 202k for colored inks, the head 206 for white ink and the head 208 for transparent ink are further used, in addition to the head 204 for modeling material, so as to model at least a part of the inner area. More specifically, for example, at least one of the heads 202y to 202k for colored inks and the head 204 for modeling material may be enabled to discharge the ink droplets to the inner area. Also, when performing the non-coloring modeling operation, at least a part of the outer periphery area, which is an area of which a color can be visibly recognized from the outside, may be formed in the same manner as the formation of the inner area.

Also, when performing the non-coloring modeling operation, the support 6 is also formed using the other inkjet heads, in addition to the head 210 for support material, like the coloring modeling operation. For example, in this illustrative embodiment, the support 6 is formed using at least the head 210 for support material and at least one of the heads 202y to 202k for colored inks. In this case, the control unit 18 enables the head 210 for support material and at least one of the heads 202y to 202k for colored inks to discharge the ink droplets to an area in which the support 6 is to be formed.

According to this illustrative embodiment, the heads 202y to 202k for colored inks and the like are used for modeling of the inner area and the like. Thereby, as compared to a configuration where the inner area is formed using only the head 204 for modeling material, it is possible to appropriately increase the modeling speed. Also, the support 6 is also formed using not only the head 210 for support material but also at least one of the heads 202y to 202k for colored inks, so that it is possible to appropriately form the support at the higher speed. In this case, the heads 202y to 202k for colored inks are necessarily required to model the colored three-dimensional object 5. For this reason, it is not necessary to add a new inkjet head just for increasing the speed. For this reason, according to the configuration of the illustrative embodiment, it is possible to appropriately increase the modeling speed of the three-dimensional object 5 without enlarging the apparatus and increasing the cost beyond necessity.

Here, the area for modeling, points to consider as regards the formation of the support 6, and the like in this illustrative embodiment are further described. In this illustrative embodiment, as described above, the area for modeling of the three-dimensional object 5 is formed using not only the head 204 for modeling material but also at least one of the heads 202y to 202k for colored inks, for example. For this reason, the area for modeling to be formed is colored by the ink of at least one color of YMCK.

In this case, a visible recognition result of the three-dimensional object 5 may be influenced depending on a method of attaching the color to the area for modeling. For example, when performing the coloring modeling operation, if a useless color is attached to a part of the inner modeling area 50, which is close to the coloring area 53, a sense of color of the three-dimensional object 5 may be changed.

For this reason, when performing the coloring modeling operation, the discharge of the ink droplets to the inner modeling area 50 positioned at the inner side of the inner white area 51 by the heads 202y to 202k for colored inks is preferably performed at a position sufficiently spaced from the inner white area 51 so that the original coloring of the three-dimensional object 5 is not influenced, for example. In this case, the position sufficiently spaced from the inner white area 51 is a position spaced by a distance or longer at which the color cannot be recognized through the inner white area 51. By this configuration, for example, it is possible to perform the formation of the inner modeling area 50, which is made using the heads 202y to 202k for colored inks, more appropriately.

Also, during the non-coloring modeling operation, if the color of the surface of the three-dimensional object 5 is too non-uniform, for example, an impression on an outward appearance of the three-dimensional object 5 may be deteriorated. For example, if the surface of the three-dimensional object 5 is randomly colored as a result of the modeling of the three-dimensional object 5 using the heads 202y to 202k for colored inks, an impression on an outward appearance of a final product may be deteriorated.

Therefore, during the non-coloring modeling operation, it is preferably to make the color of the surface of the three-dimensional object 5 uniform in a certain extent of range. In this case, the control unit 18 is configured to control the operations of the heads 202y to 202k for colored inks so that a color of the outer periphery area of the three-dimensional object 5 becomes a color within a preset range, for example. The description “a color of the outer periphery area becomes a color within a preset range” means that a color of the surface of the three-dimensional object 5 becomes a color within a predetermined range. Also, more specifically, the description “a color of the surface of the three-dimensional object 5 becomes a color within a predetermined range” means that a mixing ratio of colors as regards the inks of the respective colors of the process colors is within a predetermined range in the vicinity of the surface, for example. By this configuration, even when the three-dimensional object 5 is modeled using the heads 202y to 202k for colored inks, for example, it is possible to appropriately prevent the impression on the outward appearance of the three-dimensional object 5 from being deteriorated.

Also, as for the support 6, when the ink droplets are discharged to a position contacting the surface of the three-dimensional object 5 by the heads 202y to 202k for colored inks, for example, a color of the support 6 may spread to a position of the three-dimensional object 5 contacting the support 6. For this reason, when forming the support 6, the ink droplets are preferably discharged to the position sufficiently spaced from the surface of the three-dimensional object 5 by the heads 202y to 202k for colored inks so that the support material is contacted to the surface of the three-dimensional object 5, for example.

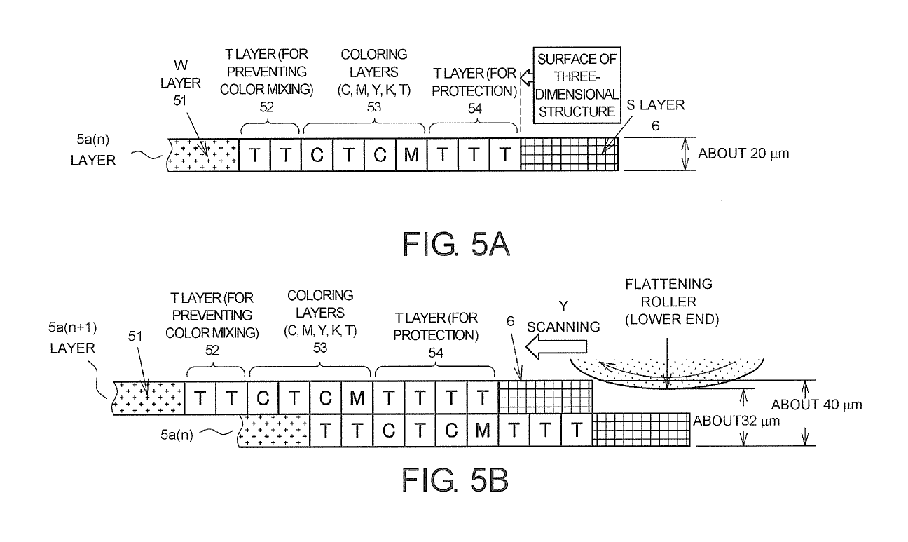

Subsequently, an operation of forming the respective layers configuring the three-dimensional object 5 according to this illustrative embodiment is described in more detail. FIGS. 4A and 4B illustrate in detail the main scanning operation that is performed in this illustrative embodiment. As described above, according to this illustrative embodiment, the respective inkjet heads of the discharge unit 12 are configured to perform the reciprocating main scanning operation in the main scanning direction. Also, during the reciprocating main scanning operation, the flattening operation is performed by the flattening roller unit 222 only during the main scanning operation in one direction.

FIG. 4A illustrates an example of a pattern of the main scanning operation in one direction (hereafter, referred to as forward direction) during the reciprocating. FIG. 4B illustrates an example of a pattern of the main scanning operation in the other direction (hereinafter, referred to as backward direction) during the reciprocating. Also, in this illustrative embodiment, the flattening by the flattening roller unit 222 is not performed during the main scanning operation in the forward direction and is performed only during the main scanning operation in the backward direction.

In the meantime, as shown in the drawings, according to this illustrative embodiment, the flattening roller unit 222 has a roller 302, a doctor blade 304 and an ink collection unit 306. The roller 302 is an example of the flattening mechanism, and is configured to flatten a surface of an ink layer formed in the main scanning operation during the main scanning operation in the backward direction. The roller 302 may be a smoothing roller configured to smooth a surface of an ink layer. Also, the roller 302 is preferably a roller having wettability as regards the ultraviolet curable resin, which is used in the discharge unit 12. The doctor blade 304 is a configuration for removing the ink scraped by the roller 302 from a surface of the roller 302. The ink collection unit 306 is a configuration for collecting the ink removed from the surface of the roller 302 by the doctor blade 304.

Also, in this illustrative embodiment, the flattening roller unit 222 is configured to be moveable in the vertical direction (Z direction) relative to the entire positions of the discharge unit 12 by a driving mechanism (not shown). Also, by this function, during the main scanning operation in the forward direction in which the flattening by the flattening roller unit 222 is not performed, for example, the flattening roller unit 222 is beforehand moved to an upper position, which is a direction getting away from the three-dimensional object 5, as shown in FIG. 4A. By this configuration, during the main scanning operation in which the flattening is not performed, it is possible to appropriately prevent the flattening roller unit 222 from contacting the ink layer.

Also, during the main scanning operation in the backward direction in which the flattening by the flattening roller unit 222 is performed, the flattening roller unit 222 is beforehand moved to a lower position, which is a direction coming close to the three-dimensional object 5, as shown in FIG. 4B. By this configuration, during the main scanning operation in which the flattening is performed, for example, it is possible to appropriately bring the flattening roller unit 222 into contact with the ink layer. In the meantime, a distance between the uppermost ink layer of the three-dimensional object 5 and the flattening roller unit 222 may also be adjusted by vertically moving the modeling platen 16 (refer to FIGS. 1A and 1B), for example.

Also, by the above configuration, during the layer forming operation of the illustrative embodiment, the discharge unit 12 is first moved in a predetermined direction (for example, rightward direction in the drawing), as shown in FIG. 4A, for example, so that the main scanning operation in the forward direction is performed. Also, when performing the coloring modeling operation, for example, the ink droplets are discharged from the respective inkjet heads of the discharge unit 12 on the basis of modeling data, which is the shape information of a three-dimensional structure, and coloring data, which is the color image information. Also, when performing the non-coloring modeling operation, the ink droplets are discharged from the respective inkjet heads of the discharge unit 12 on the basis of the modeling data. In the meantime, during the main scanning operation in the forward direction, the flattening roller unit 222 is retreated upwards by the driving mechanism. For this reason, a lower end of the roller 302 is not contacted to an upper surface of the three-dimensional object 5 being modeled.

Also, during the main scanning operation, the ultraviolet light source 220 (UV1) arranged at the rear of the discharge unit 12 with respect to the moving direction is turned on, so that the ink layer formed at the uppermost part of the three-dimensional object 5 is cured. Thereby, during the one main scanning operation, the curing operation is performed at the same time as the layer forming operation. In the meantime, the ink layer formed during this main scanning operation is the 5a(n) layer shown in FIG. 3A, for example.

Also, subsequently to the above process, the position of the modeling platen 16 is lowered in the vertical direction (Z direction) by a predetermined height in conformity to a thickness of an ink layer to be formed next time. In this case, according to the illustrative embodiment, the position of the modeling platen 16 is lowered in consideration of a thickness of the ink layer, which is to be removed by the flattening of the flattening roller unit 222.

For example, in this illustrative embodiment, whenever the reciprocating main scanning operation is performed, the modeling platen 16 is lowered. In this case, for example, the modeling platen 16 is lowered by a height corresponding to a value obtained by subtracting a thickness of the ink, which is to be removed by the flattening, from a double thickness of the ink layer, which is to be formed when performing the main scanning operation without the flattening. Also, more specifically, for example, when a thickness of the ink layer, which is to be formed when performing the main scanning operation without the flattening, is about 20 μm, a thickness of the double layer is about 40 μm. When a thickness of the ink, which is to be removed by the flattening, is about 8 μm, the modeling platen 16 is lowered by a distance of about 32 μm.

Also, subsequently to the operation of lowering the modeling platen 16, the main scanning operation in the backward direction is performed by moving the discharge unit 12 in an opposite direction (for example, leftward direction in the drawing) to the forward direction, as shown in FIG. 4B. Thereby, for example, when performing the coloring modeling operation, the ink droplets are discharged from the respective inkjet heads of the discharge unit 12 on the basis of the modeling data and the coloring data. Also, when performing the non-coloring modeling operation, the ink droplets are discharged from the respective inkjet heads of the discharge unit 12 on the basis of the modeling data.

Also, during the main scanning operation in the backward direction, the flattening roller unit 222 is moved downwards by the driving mechanism. Thereby, the lower end of the roller 302 is contacted to the upper surface of the three-dimensional object 5 being modeled. For this reason, during the main scanning operation in the backward direction, the roller 302 scrapes and removes the ink on the surface of the ink layer. Also, thereby, the roller 302 flattens the ink layer.

Also, during this main scanning operation, the ultraviolet light source 220 (UV2) positioned at the rear of the discharge unit 12 with respect to the moving direction is turned on, so that the ink layer formed at the uppermost part of the three-dimensional object 5 is cured. In the meantime, the ink layer formed during this main scanning operation is the 5a(n+1) layer shown in FIG. 3A, for example.

Thereafter, the above operations are repeated. Thereby, for example, it is possible to appropriately model the colored three-dimensional object 5. Also, in this case, during the main scanning operation in which the flattening is performed by the roller 302, the position (position in the Z direction) of the lower end of the roller 302 in the vertical direction is constant each time. For this reason, the roller 302 flattens the ink layer each time to the size (for example, 32 μm) relating to the moving distance of the modeling platen 16 before the flattening. For this reason, according to the illustrative embodiment, it is possible to appropriately perform the flattening of the ink layer with high precision, for example.

Also, as described above, in this illustrative embodiment, the ink layer having the respective areas described with reference to FIGS. 3A and 3B and the like is formed by the main scanning operation each time. In this case, the area for modeling is formed using the color inks (YMCK inks) and the like, in addition to the modeling ink to be discharged from the head 204 for modeling material. Also, at least a part of the support 6 is formed using the color inks and the like, in addition to the ink for support to be discharged from the head 210 for support material. For this reason, according to the illustrative embodiment, it is possible to appropriately increase the modeling speed, as compared to a case where the area for modeling is formed using only the head 204 for modeling material or a case where the support 6 is formed using only the head 210 for support material.

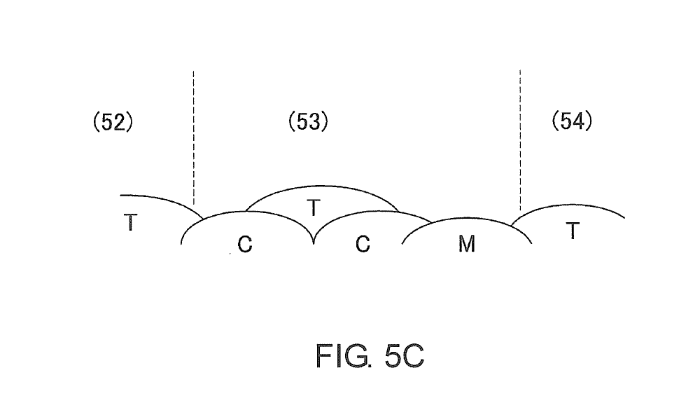

Subsequently, a pattern of the ink layer formed in the illustrative embodiment is described in more detail. FIGS. 5A to 5C illustrate examples of more specific patterns of the 5a(n) layer and the 5a(n+1) layer, which are the ink layers, when performing the coloring modeling operation. The 5a(n) layer and the 5a(n+1) layer are layers denoted with the reference numerals 5a(n) and 5a(n+1) in FIG. 3A.

FIG. 5A is a pictorial view illustrating an example of a pattern upon the formation of the 5a(n) layer. As described above, the 5a(n) layer is an ink layer that is foamed by the main scanning operation in the forward direction. In this case, during the main scanning operation, the discharge unit 12 is configured to discharge the ink droplets while moving in the rightward direction in the drawing. Also, as a result, when the discharge unit 12 having the configuration as shown in FIGS. 4A and 4B and the like is used, the ink droplets of the transparent ink (T), which are discharged from the head 208 for transparent ink (the inkjet head positioned at the right end), are first attached (spotted) to the coloring area 53, which is formed using the CMYK inks and the transparent ink during the coloring modeling operation, for example. Thereafter, the ink droplets of the respective colors of K, C, M and Y are sequentially attached in accordance with the alignment sequence of the inkjet heads from right.

Meanwhile, in FIG. 5A, for convenience of illustrations, an ink dot formed by one ink droplet is pictorially shown by one rectangle. However, in the actual configuration, the ink dots adjacent to each other are formed so that at least parts thereof overlap with each other. In this case, an ink dot that is to be formed by an ink droplet to be attached later is superimposed on an ink dot that is to be formed by an ink droplet to be attached first.

Also, as shown in FIG. 5A, during the main scanning operation in the forward direction, the discharge unit 12 is configured to discharge the ink droplets from the inkjet heads relating to the respective areas, thereby forming the inner white area 51, the inner transparent area 52 and the outer transparent area 54, in addition to the coloring area 53. Also, the support 6 is formed on the outer side of the surface of the three-dimensional object 5, which is shown with the broken line in the drawing as a surface of the three-dimensional structure.

FIG. 5B is a pictorial view illustrating an example of a pattern upon the formation of the 5a(n+1) layer. As described above, the 5a(n+1) layer is an ink layer that is formed by the main scanning operation in the backward direction. In this case, during the main scanning operation, the discharge unit 12 is configured to discharge the ink droplets while moving in the leftward direction in the drawing. Also, as a result, when discharging the ink droplets to the same positions of the three-dimensional object 5 by using the discharge unit 12 having the configuration of this illustrative embodiment, the ink droplets discharged from the left inkjet heads are sequentially attached in order. More specifically, when discharging the ink droplets to the same positions, the ink droplets from the head 210 for support material of the discharge unit 12, which is positioned at the left end, are first attached. After that, the ink droplets are attached in order of MO, W, . . . , and the ink droplets of the transparent ink (T) are finally attached. Also, during the coloring modeling operation, the ink droplets of the respective colors of Y, C, M and K are sequentially attached to the coloring area 53, and then the ink droplets of the transparent ink (T) are attached.

Here, as described above, in the actual configuration, the ink dots adjacent to each other are formed so that at least parts thereof overlap with each other, for example. Since the droplets are attached in above order, the dot of the transparent ink (T), which is to be attached later than the other colors, is formed at a position higher than the ink dots of the other colors on the 5a(n+1) layer. Also, the dots of the colored inks such as YMCK inks are not formed at least on the dot of the transparent ink (T).

Also, FIG. 5C illustrates an example of an actual arranging method as regards the arranging method of the ink dots to be formed by the main scanning operation in the backward direction. As shown, in the coloring area 53, for example, a dot of the transparent ink is formed at a position higher than the dots of the inks of the respective colors of CMYK. In this case, during the flattening operation, the roller 302 is mainly contacted to the transparent ink. For this reason, by this configuration, in the coloring area 53, for example, it is possible to appropriately prevent the states of the colored inks such as YMCK inks from being disordered due to the roller 302. Also, it is possible to appropriately prevent the colored inks of different colors from being mixed and color-bleeding. Further, the same effects are accomplished as regards the contact with the transparent inks in the inner transparent area 52 and the outer transparent area 54, too.

In this case, as described above with reference to FIGS. 4A and 4B, the position (position in the Z direction) of the lower end of the roller 302 in the vertical direction is constant each time. For this reason, the roller 302 flattens the ink layer each time to the size (for example, 32 μm) relating to the moving distance of the modeling platen 16 before the flattening. For this reason, according to the illustrative embodiment, it is possible to appropriately perform the flattening of the ink layer with high precision, for example.

As described above, in this illustrative embodiment, the flattening is performed by the roller 302, for example, so that it is possible to appropriately model the three-dimensional object 5 with high precision. Also, the flattening is performed by the configuration where the transparent ink is mainly contacted to the roller 302. Thereby, it is possible to appropriately prevent the color bleeding and the like. For this reason, according to the illustrative embodiment, when performing the coloring modeling operation, for example, it is possible to model the colored three-dimensional object 5 more appropriately.

Also, when performing the non-coloring modeling operation, as described above, the apparatus 10 for modeling a three-dimensional object forms only the area for modeling, for example, as the inner area and outer periphery area of the three-dimensional object 5. Also in this case, during the main scanning operation in the backward direction, for example, the flattening is preferably performed by the roller 302. By this configuration, even when performing the non-coloring modeling operation, for example, it is possible to model the three-dimensional object 5 more appropriately.

Also, in this illustrative embodiment, as described above, the heads 202y to 202k for colored inks and the like are additionally used to form the inner area or the support 6, so that the modeling speed of the three-dimensional object 5 is increased. By this configuration, when performing the non-coloring modeling operation, for example, it is possible to increase the modeling speed, particularly. In the below, this is described in more detail.

When performing the coloring modeling operation, it is necessary to discharge the ink droplets to the respective spotting positions, which are set depending on a resolution of the coloring, by the respective heads 202y to 202k for colored inks. For this reason, in order to color the three-dimensional object 5 with a high resolution, for example, it may be required to perform the main scanning operation by a multipath method. In this case, the multipath method is an operation of discharging the ink droplets to some spotting positions, which are designated by preset mask data, during each main scanning operation. Also, in this case, the control unit 18 is configured to enable the heads 202y to 202k for colored inks to discharge the ink droplets to the coloring area 53 by the multipath method. By this configuration, it is possible to more appropriately perform the coloring of the three-dimensional object with high precision, for example. However, when the ink droplets are discharged by the multipath method, the modeling speed is lowered because the number of times of the main scanning operations to be performed increases.

On the other hand, when performing the non-coloring modeling operation, it is not necessarily required to discharge the ink droplets by the multipath method. Also, in this illustrative embodiment, the ink droplets are discharged to the area for modeling, for example, by using the other inkjet heads such as the heads 202y to 202k for colored inks, in addition to the head 204 for modeling material. Also, the ink droplets are discharged to the area for forming the support 6 by using the other inkjet heads such as the heads 202y to 202k for colored inks, in addition to the head 210 for support material.

For this reason, it is possible to discharge the ink droplets to the area for modeling or the area for forming the support 6 with a high density by one main scanning operation. In this case, it is possible to discharge the ink droplets with the sufficient density by one main scanning operation, even without discharging the ink droplets by the multipath method.

For this reason, when performing the non-coloring modeling operation, the control unit 18 may enable the respective inkjet heads to discharge the ink droplets by one path. In this case, the description “the ink droplets are discharged by one path” means that one ink layer is formed by one path, for example. By this configuration, it is possible to increase the modeling speed more appropriately, as compared to a configuration where the ink droplets are discharged by the multipath method, for example. Also, it is possible to increase the modeling speed more appropriately when performing the non-coloring modeling operation.

Also, in this illustrative embodiment, when performing any of the coloring modeling operation and the non-coloring modeling operation, the ink droplets are discharged to the area for modeling by using the other inkjet heads such as the heads 202y to 202k for colored inks, in addition to the head 204 for modeling material. Also, the ink droplets are discharged to the support 6 by using the other inkjet heads such as the heads 202y to 202k for colored inks, in addition to the head 210 for support material.

However, in a modified embodiment of the apparatus 10 for modeling a three-dimensional object, the ink droplets may be discharged to the area for modeling by using the other inkjet heads such as the heads 202y to 202k for colored inks, in addition to the head 204 for modeling material, only when performing the non-coloring modeling operation. In this case, during the coloring modeling operation, the inner modeling area 50 is formed using only the head 204 for modeling material. Also, the ink droplets may be discharged to the support 6 by using the other inkjet heads such as the heads 202y to 202k for colored inks, in addition to the head 210 for support material, only when performing the non-coloring modeling operation. In this case, during the coloring modeling operation, the support 6 is formed using only the head 210 for support material. Also in this case, it is possible to form the inner modeling area 50 and the support 6 at appropriate speed by discharging the ink droplets by the multipath method during the coloring modeling operation.

Also, in this illustrative embodiment, as described above, the other inkjet heads such as the heads 202y to 202k for colored inks are further used to discharge the ink droplets to the area for modeling and the area for forming the support 6, in addition to the inkjet heads for modeling and support. In this case, each area is formed by the multiple inkjet heads, so that it is possible to accomplish a special effect of making the thickness of the formed layer uniform, as compared to a configuration where each layer is formed using a single inkjet head. That is, in this case, since the multiple inkjet heads scan on the same scanning line, the non-uniformity of the amount of the ink droplets discharged from the respective nozzles of each head is averaged and the thickness of the layer is uniform, so that it is possible to model the three-dimensional object with high precision.

In the meantime, as described above, when forming one layer in the area for modeling and the area for forming the support 6 with one main scanning operation by the multiple inkjet heads, the discharging method is not particularly limited inasmuch as a positional relation with which the droplets discharged from the respective inkjet heads do not overlap with each other is made. For instance, one layer may be formed with the positional relation with which the droplets do not overlap with each other, by enabling all the nozzles of the respective inkjet heads to discharge the droplets on the basis of the data and making the discharge timings of the respective inkjet heads different.

Subsequently, the features of using the heads 202y to 202k for colored inks upon the formation of the inner modeling area 50 or support 6 are further described. As described above, regarding the operations of the apparatus 10 for modeling a three-dimensional object described with reference to FIGS. 1A to 5C, when performing any of the coloring modeling operation and the non-coloring modeling operation, for example, the ink droplets are discharged to the area for modeling by using the other inkjet heads such as the heads 202y to 202k for colored inks and the like, in addition to the head 204 for modeling material. Also, the ink droplets are discharged to the support 6 by using the other inkjet heads such as the heads 202y to 202k for colored inks and the like, in addition to the head 210 for support material. For this reason, the support 6 shown in FIGS. 5A and 5B or the inner modeling area 50 (not illustrated) is formed using at least one of the heads 202y to 202k for colored inks.

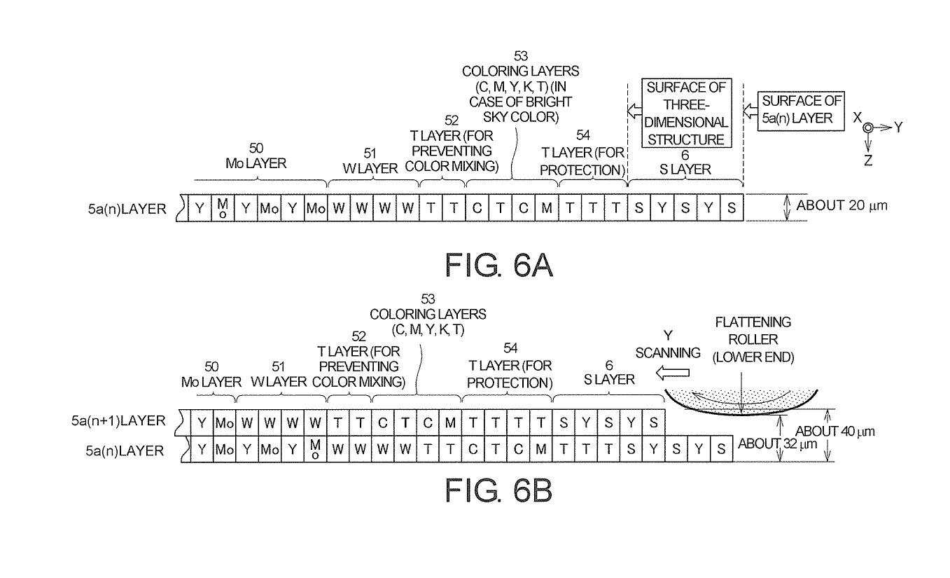

FIGS. 6A and 6B illustrate in detail an example of the configuration of each area to be formed by the coloring modeling operation. FIGS. 6A and 6B illustrate in detail examples of the configuration of the 5a(n) layer and the 5a(n+1) layer shown in FIGS. 5A and 5B.

In the example shown in FIGS. 6A and 6B, the apparatus 10 for modeling a three-dimensional object (refer to FIGS. 1A and 1B) is configured to foil the inner modeling area 50 (Mo layer) by using the head 202y for colored ink (refer to FIGS. 3A and 3B), in addition to the head 204 for modeling material (refer to FIG. 2). Also, the apparatus is configured to form the support 6 by using the head 202y for colored ink, in addition to the head 210 for support material (refer to FIGS. 3A and 3B). In this case, the control unit 18 (refer to FIGS. 1A and 1B) of the apparatus 10 for modeling a three-dimensional object is configured to enable the head 202y for colored ink and the head 204 for modeling material to discharge the ink droplets towards the modeling platen 16, thereby forming the respective ink layers configuring the inner modeling area 50. Also, the apparatus is configured to enable the head 202y for colored ink and the head 210 for support material to discharge the ink droplets towards the modeling platen 16, thereby forming the respective ink layers configuring the support 6. By this configuration, it is possible to appropriately form the inner modeling area 50 or support 6 at high speed by mixing the colored ink with the modeling ink or material of the support 6 and discharging the same.

Here, in the configuration shown in FIGS. 6A and 6B, the ink of Y color used for formation of the inner modeling area 50 or support 6 is an example of the colored ink. In a modified embodiment of the apparatus 10 for modeling a three-dimensional object, the inner modeling area 50 or support 6 may be formed by discharging the ink droplets of a color except for Y color from the head 202m, 202c or 202k for colored ink except for the head 202y for colored ink. Also, a plurality of types of colored inks may be used.

In this case, the speeding-up of the modeling by using the heads 202y to 202k for colored inks is more generally described. For example, it can be said that when the ink droplets are discharged from not only the head 204 for modeling material and the head 210 for support material but also at least one of the heads 202y to 202k for colored inks, it is possible to implement the speeding up in accordance with the number of the inkjet heads to be used, as regards the modeling speed of the inner modeling area 50 or support 6. For example, when the inner modeling area 50 (or support 6) is formed by discharging the inks from the head 204 for modeling material (or head 210 for support material) and the heads 202y to 202k for colored inks with a ratio of 50%, respectively, it is possible to twice increase the modeling speed, as compared to a configuration where the modeling is performed using only the head 204 for modeling material (or head 210 for support material). Also, when some heads (for example, two heads) of the heads 202y to 202k for colored inks are used and the discharge amount of the inks from the heads 202y to 202k for colored inks is twice increased, as compared to the discharge amount of the ink from the head 204 for modeling material (or head 210 for support material), it is possible to increase the modeling speed three times, as compared to a configuration where the modeling is performed using only the head 204 for modeling material (or head 210 for support material).

Also, in a modified embodiment of the apparatus 10 for modeling a three-dimensional object, the modeling may be performed with some areas (for example, the inner transparent area 52, the outer transparent area 54 or the like) being omitted. Also, when performing the non-coloring modeling operation, the modeling may be performed by a configuration where the coloring area 53 is excluded from the configuration shown in FIGS. 6A and 6B, for example. Also, in this case, the inner transparent area 52 and the outer transparent area 54 may be further omitted. Also, the inner white area 51 may be further omitted.

Also, regarding the effects accomplished by using the colored ink to form the inner modeling area 50 or support 6, the speeding up of the modeling speed has been mainly described. However, it is possible to accomplish further effects by the configuration, in addition to the speeding up. In the below, the effects are described in more detail.

The ink that is used in the inkjet head typically has a property depending on a composition and a type of the ink. For this reason, when the colors and types of the inks are different, the properties of the inks are also different. In this case, the property is a color, hardness, elasticity, strength and the like. For this reason, when forming the inner modeling area 50 or support 6 by additionally using the colored inks, i.e., using the plurality of types of inks, it is also possible to change the property of the inner modeling area 50 or support 6 by adjusting a ratio of the colored inks.

More specifically, for example, when the colored ink is further used to model the inner modeling area 50, in addition to the modeling ink (modeling material), it is possible to variously change the various property values (for example, color, hardness, elasticity, strength and the like) of the ink layers configuring the inner modeling area 50 by changing a mixing ratio. Also, in this case, it is possible to make the property values different for each part of the three-dimensional object.

Also, it is considered to use the ink of which a property difference from the colored ink is large, for the head 210 for support material, as the material of the support 6. In this case, regarding the composition of the support 6, it may be possible to variously change the property of the support 6 by adjusting a ratio between the ink (support material) to be discharged from the head 210 for support material and the inks (colored ink) to be discharged from the heads 202y to 202k for colored inks. Also, thereby, it is possible to form the support 6 having a desired property more appropriately, for example.

More specifically, as the ink for the head 210 for support material, it is considered to use a material having high adhesiveness to the modeling platen 16 so as to securely support the three-dimensional object being modeled by the support 6. In this case, however, there are concerns that if the adhesiveness of the support 6 to the modeling platen 16 is excessively high, it may be difficult to detach the three-dimensional object from the mounting table after the completion of the modeling. Also, the force is applied beyond necessity upon the detachment, so that the three-dimensional object may be damaged.

For this reason, in this case, for example, it is considered to form the support 6 by further using the colored ink having different adhesiveness to the modeling platen 16 from the ink used for the head 210 for support material. In this case, more specifically, it is considered to use the ink having lower adhesiveness to the modeling platen 16 than the ink for the head 210 for support material, as the colored ink. By this configuration, it is possible to adjust the adhesiveness of the support 6 to the modeling platen 16 within an appropriate range by adjusting the ratio of the inks configuring the support 6. Also, thereby, it is possible to more easily detach the three-dimensional object from the modeling platen 16.

In the meantime, when modeling the three-dimensional object, it may also be considered to place a plate (for example, resin plate), a sheet and the like on the modeling platen 16 and then to model the three-dimensional object thereon. In this case, the adhesion strength to the modeling platen 16 may be adhesion strength to the plate, the sheet and the like placed on the modeling platen 16.

Also, regarding the colored inks in the support 6, it may be considered to form a variety of structures in the support 6 with the colored inks not only by using the colored inks with a predetermined ratio but also by discharging the ink droplets to the preset positions. Also, as the corresponding structure, it may be considered to use preset structures depending on various purposes. In the below, examples of the structure are described.

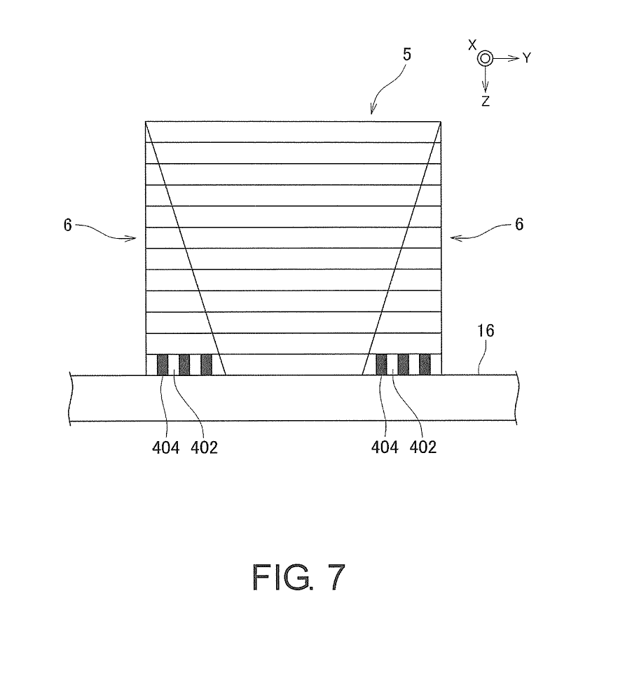

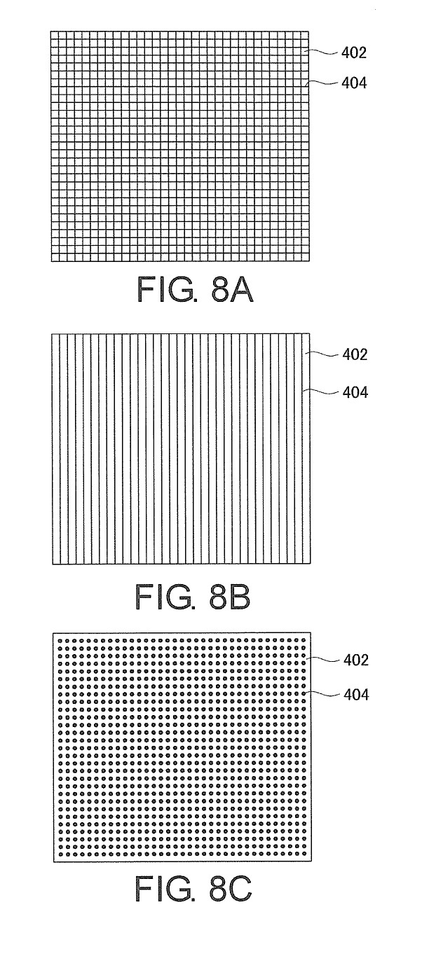

FIGS. 7 and 8 illustrate an example of the structure that is to be formed in the support 6 by the colored inks, i.e., an example of the structure that is to be formed for the purpose of controlling the adhesiveness of the support 6 to the modeling platen 16. FIG. 7 is a vertical sectional view of the three-dimensional object 5 being modeled and the support 6.

The adhesiveness of the support 6 to the modeling platen 16 is likely to be influenced by the property of an area of the support 6, which is in contact with the modeling platen 16. For this reason, when controlling the adhesiveness of the support 6 by using the colored ink, it is preferable to enable any one of the heads 202y to 202k for colored inks to discharge the ink droplets at least upon formation of an ink layer of the support 6 closest to the modeling platen 16. In this case, the ink layer closest to the modeling platen 16 is the lowest ink layer that is to be first formed on the modeling platen 16, for example.

More specifically, in this case, it is considered to form an ink layer including a support material area 402 and a coloring ink area 404, at least as the lowest layer of the support 6. In this case, the support material area 402 is an area that is to be formed by the head 210 for support material. Also, the coloring ink area 404 is an area that is to be formed by any one of the heads 202y to 202k for colored inks. By this configuration, for example, it is possible to appropriately form the lowest ink layer of the support 6 contacting the modeling platen 16 by using the head 210 for support material and the heads 202y to 202k for colored inks. Also, it is possible to adjust the adhesiveness of the support 6 to the modeling platen 16 more appropriately.

Also, the coloring ink area 404 is not limited to the lowest layer of the support 6 and may be formed in a higher layer. Also, in this case, it is considered to form the support material area 402 and the coloring ink area 404 in the support 6 in accordance with a preset pattern.

FIGS. 8A to 8C illustrate a pattern for forming the support material area 402 and the coloring ink area 404. FIGS. 8A to 8C illustrate examples of the pattern for forming the support material area 402 and the coloring ink area 404.

In the support 6 configured by the support material area 402 and the coloring ink area 404, regarding a discharge pattern of the coloring ink to be discharged by at least one of the heads 202y to 202k for colored inks and the support material to be discharged by the head 210 for support material, a discharge pattern is considered in which the coloring ink area 404 is formed into a lattice shape by discharging the coloring ink to a lattice-shaped area and the support material area 402 is formed by discharging the support material into each lattice of the coloring ink area 404, as shown in FIG. 8A, for example. Also, for example, as shown in FIG. 8B, a discharge pattern is considered in which the coloring ink area 404 is formed into a stripe shape and the support material area 402 is formed between stripes of the coloring ink area 404. Also, for example, as shown in FIG. 8C, a discharge pattern is considered in which the coloring ink area 404 is formed into a dot shape and the support material area 402 is formed between spots of the coloring ink area 404.

When the support 6 is formed with the above-described discharge pattern, a boundary part between the support material area 402 and the coloring ink area 404 exists in the support 6. Therefore, when detaching the three-dimensional object from the modeling platen 16, the stress spreads at the boundary part, so that the three-dimensional object can be easily detached. Also, thereby, it is possible to easily and appropriately detach the three-dimensional object from the modeling platen 16.

In the meantime, the discharge pattern for forming the support material area 402 and the coloring ink area 404 is not limited to the above examples, and a variety of different patterns may also be used. In this case, the coloring ink area 404 is preferably foamed into a line shape (for example, a stripe shape or a lattice shape). By this configuration, it is possible to more easily spread the stress when detaching the three-dimensional object from the modeling platen 16. Also, thereby, it is possible to easily and appropriately detach the three-dimensional object.

Also, in the various discharge patterns, it is preferable to appropriately adjust a size of each area and the like. For example, it is preferable to appropriately adjust a lattice width, an interval of the stripes, an interval of the dots and the like of the coloring ink area 404. Also, for example, when forming the coloring ink area 404 into a line shape, it is preferable to adjust a thickness, a density and the like of the line. Also, in this case, it is considered to adjust the thickness, the density and the like of the line of the coloring ink area 404, depending on the adhesion strength of the support material area 402 to the modeling platen 16. By this configuration, for example, it is possible to adjust the adhesion strength of the entire support 6 to the modeling platen 16 more appropriately.

Also, when the adhesion strengths of the support material area 402 and the coloring ink area 404 to the modeling platen 16 are different, it can be said that the hardness and the like of the support material area 402 and coloring ink area 404 after the curing are different. For this reason, it can be said that the support material area 402 and the coloring ink area 404 are areas of which at least one of the hardness, the stiffness and the elasticity after the curing is different.

Also, it is possible to obtain further effects, in addition to the above effects, by forming the coloring ink area 404 in the support 6. For example, it is possible to form the colored support 6 by forming the coloring ink area 404 in the support 6. In this case, for example, since the remnants, which remain without being removed upon the removal of the support 6, are seen well, for example, it is possible to perform the removing operation more easily.

Also, in order to easily remove the support 6 after the modeling, a material having a deliquescent property, for example, may be used as the support material for the head 210 for support material. In this case, the coloring ink area 404 to be formed in the support 6 may be made to function as a darn for preventing deliquescence. Also, thereby, it is possible to improve the strength of the support 6 more appropriately, for example.

Also, it may be possible to appropriately improve the strength of the support 6 by forming the coloring ink area 404 in the support 6, irrespective of whether or not the deliquescent property. More specifically, in this case, for example, it is considered to form a pillar-shaped body (pillar), which is formed as the colored inks overlap with each other, as the coloring ink area 404 in the support 6.

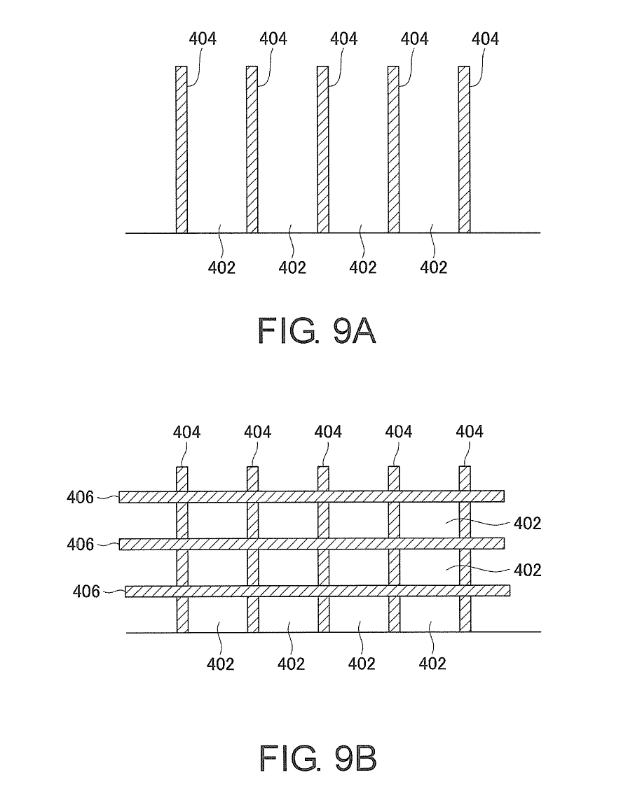

FIGS. 9A and 9B illustrate a configuration of the support 6 when forming a pillar-shaped body of the colored ink. FIG. 9A illustrates an example of the configuration of the support 6.

In the example of FIG. 9A, the coloring ink areas 404 having a shape of a pillar-shaped body extending in a stacking direction of the ink layer are arranged in the support 6. In this case, for example, regarding a plurality of ink layers to be stacked, the respective ink layers are formed so that areas to be formed of the colored ink overlap between the layers. Thereby, the coloring ink area 404 having a shape of a pillar-shaped body is formed. Also, the multiple coloring ink areas 404 are preferably formed so that they are aligned at a constant interval in an in-plane direction of the ink layer, for example. Also, in this case, the parts except for the coloring ink areas 404 in the support 6 are filled with the support material discharged from the head 210 for support material, so that they become the support material areas 402.

By this configuration, for example, it is possible to appropriately form the stronger support 6 supported with the pillar-shaped body. Also, in this case, since the support material area 402 between the coloring ink areas 404 can be formed of the support material that can be easily removed, the support 6 can be easily removed. For this reason, by this configuration, it is possible to more appropriately form the support 6, which has the strong configuration capable of more securely supporting the three-dimensional object being modeled and can be easily removed.

Also, in order to further strengthen the support 6, it may be considered not only to form the coloring ink area 404 into the pillar-shaped body but also to form an area connecting a plurality of pillar-shaped bodies with a further colored ink. FIG. 9B illustrates another example of the configuration.

In the example of FIG. 9B, coloring ink areas 406, which are film-shaped areas connecting the multiple coloring ink areas 404, are further formed of the colored ink in the support 6, in addition to the coloring ink areas 404 having a shape of a pillar-shaped body. The coloring ink area 406 may be an ink layer formed of the colored ink, for example. By this configuration, the areas formed of the colored inks are connected in a mesh shape in the support 6. Also, in this case, an area surrounded by the coloring ink area 404 and the coloring ink area 406 becomes the support material area 402. For this reason, by this configuration, it is possible to more appropriately form the stronger support 6, for example.

Also, in this case, the material of the support 6, which is to be discharged by the head 210 for support material, is accommodated in a container-shaped area of which a periphery is surrounded by the areas formed of the colored inks. For this reason, by this configuration, it is possible to more appropriately maintain the support material in the gap of the areas formed of the colored inks. Also, for example, when a material, which can be more easily removed, is used as the support material, it is possible to rigidly maintain the entire shape of the support 6 even though it is difficult to maintain the constant shape only by the support material. For this reason, by this configuration, it is possible to provide the strong configuration capable of more securely supporting the three-dimensional object being modeled and to more appropriately form the support 6 that can be easily removed.

Although the illustrative embodiment of the present disclosure has been described, the technical scope of the present disclosure is not limited to the illustrative embodiment. It is obvious to one skilled in the art that the illustrative embodiment can be variously changed or improved. It is clear from the claims that the changes or improvements can also be included in the technical scope of the present disclosure.

### INDUSTRIAL APPLICABILITY

The present disclosure can be appropriately applied to the apparatus for modeling a three-dimensional object, for example.

### DESCRIPTION OF REFERENCE NUMERALS

5: three-dimensional object, 6: support

10: apparatus for modeling a three-dimensional object

12: discharge unit, 14: main scanning driving unit, 16: modeling platen

18: control unit, 50: inner modeling area, 51: inner white area

52: inner transparent area, 53: coloring area, 54: outer transparent area

102: carriage, 104: guide rail, 202y to 202k: heads for colored inks

204: head for modeling material, 206: head for white ink

208: head for transparent ink, 210: head for support material

220: ultraviolet light source, 222: flattening roller unit, 302: roller

304: doctor blade, 306: ink collection unit, 402: support material area

404: coloring ink area, 406: coloring ink area

What is claimed is:

1. An apparatus for modeling a three-dimensional object configured to use a curable resin and to model a three-dimensional object by a lamination modeling method, the curable resin being a resin that is cured depending on a predetermined condition, the apparatus comprising:
a plurality of heads for colored inks comprising the curable resin and configured to discharge ink droplets of colored inks having different colors from each other by an inkjet method;
a curing unit configured to cure the curable resin, and
a control unit configured to control operations of the plurality of heads for colored inks and the curing unit,
wherein when coloring at least a surface of the three-dimensional object on the basis of an image prepared in advance, the control unit enables the plurality of heads for colored inks to discharge the ink droplets, based on the image, to at least an outer periphery area of the three-dimensional object, which is an area of which a color is capable of being visibly recognized from an outside of the three-dimensional object, and
wherein at least when not coloring the surface of the three-dimensional object on the basis of the image, the control unit enables at least one of the heads for colored inks to discharge the ink droplets to an inner area, which is an area positioned at an inner side of the outer periphery area.

2. The apparatus for modeling a three-dimensional object according to claim 1, wherein the curable resin is an ultraviolet curable resin that is cured by ultraviolet irradiation, and
wherein the curing unit is an ultraviolet light source configured to generate ultraviolet for curing the ultraviolet curable resin.

3. The apparatus for modeling a three-dimensional object according to claim 1, wherein even when coloring the surface of the three-dimensional object on the basis of the image, the control unit enables at least one of the heads for colored inks to discharge the ink droplets to the inner area.

4. The apparatus for modeling a three-dimensional object according to claim 1, wherein inkjet heads for respective colors of process colors are provided as the plurality of heads for colored inks, and
wherein at least one of the heads for colored inks configured to discharge the ink droplets to the inner area is an inkjet head for any one color of the process colors.

5. The apparatus for modeling a three-dimensional object according to claim 1, wherein when not coloring the surface of the three-dimensional object on the basis of the image, the control unit controls operations of the plurality of heads for colored inks so that a color of the outer periphery area becomes a color within a preset range.

6. The apparatus for modeling a three-dimensional object according to claim 1, further comprising: a head for achromatic ink configured to discharge ink droplets of achromatic ink by the inkjet method,
wherein at least when not coloring the surface of the three-dimensional object on the basis of the image, the control unit enables the head for achromatic ink to discharge the ink droplets to at least the inner area.

7. The apparatus for modeling a three-dimensional object according to claim 6, wherein the achromatic ink is white ink or transparent ink.

8. The apparatus for modeling a three-dimensional object according to claim 6, wherein the achromatic ink is transparent ink, and
wherein when coloring the surface of the three-dimensional object on the basis of the image, the control unit enables the head for achromatic ink to discharge the ink droplets to at least a coloring area of the outer periphery area.

9. The apparatus for modeling a three-dimensional object according to claim 1, further comprising: a head for modeling material configured to discharge ink droplets of ink for modeling the three-dimensional object and having a color different from the plurality of heads of colored inks by the inkjet method,
wherein at least when not coloring the surface of the three-dimensional object on the basis of the image, the control unit enables at least one of the heads for colored inks and the head for modeling material to discharge the ink droplets to the inner area.

10. The apparatus for modeling a three-dimensional object according to claim 9, further comprising: a mounting table configured to place the three-dimensional object being modeled on an upper surface thereof,
wherein the control unit is configured to enable at least one of the heads for colored inks and the head for modeling material to discharge the ink droplets towards the mounting table, thereby forming respective ink layers configuring the inner area.

11. The apparatus for modeling a three-dimensional object according to claim 1, further comprising: a head for support material configured to discharge ink droplets, which become a material of a support layer configured to surround an outer periphery of the three-dimensional object being modeled and to support the three-dimensional object, by the inkjet method,
wherein the control unit is configured to enable the head for support material to discharge the ink droplets to an area in which the support layer is to be formed, and
wherein at least when not coloring the surface of the three-dimensional object on the basis of the image, the control unit also enables at least one of the heads for colored inks to discharge the ink droplets to the area in which the support layer is to be formed.

12. The apparatus for modeling a three-dimensional object according to claim 11, wherein the head for support material and at least one of the heads for colored inks are configured to discharge ink droplets of inks having different properties to the area in which the support layer is to be formed.

13. The apparatus for modeling a three-dimensional object according to claim 11, further comprising: a mounting table configured to place the three-dimensional object being modeled on an upper surface thereof,
wherein the head for support material and at least one of the heads for colored inks are configured to discharge ink droplets of inks having different adhesion strengths to the mounting table to the area in which the support layer is to be formed.

14. The apparatus for modeling a three-dimensional object according to claim 13, wherein the control unit is configured to enable at least one of the heads for colored inks to discharge the ink droplets to the area in which the support layer is to be formed at least upon formation of an ink layer of the support layer closest to the mounting table.

15. The apparatus for modeling a three-dimensional object according to claim 11, further comprising: a mounting table configured to place the three-dimensional object being modeled on an upper surface thereon,
wherein the control unit is configured to enable at least one of the heads for colored inks and the head for support material to discharge the ink droplets towards the mounting table, thereby forming respective ink layers configuring the support layer.

16. The apparatus for modeling a three-dimensional object according to claim 11, wherein the control unit is configured to enable at least one of the heads for colored inks to discharge the ink droplets to the area in which the support layer is to be formed, thereby forming a pillar-shaped body, which is formed as the colored inks overlap with each other, in the support layer.

17. A method for modeling a three-dimensional object configured to use a curable resin and to model a three-dimensional object by a lamination modeling method, the curable resin being a resin that is cured depending on a predetermined condition, the method using:
a plurality of heads for colored inks comprising the curable resin and configured to discharge ink droplets of colored inks having different colors from each other by an inkjet method, and
a curing unit configured to cure the curable resin, and
the method comprising:
controlling operations of the plurality of heads for colored inks and the curing unit,
when coloring at least a surface of the three-dimensional object on the basis of an image prepared in advance, enabling the plurality of heads for colored inks to discharge the ink droplets, based on the image, to at least an outer periphery area of the three-dimensional object, which is an area of which a color is capable of being visibly recognized from an outside of the three-dimensional object, and
at least when not coloring the surface of the three-dimensional object on the basis of the image, enabling at least one of the heads for colored inks to discharge the ink droplets to an inner area, which is an area positioned at an inner side of the outer periphery area.

18. An apparatus for modeling a three-dimensional object configured to use a curable resin and to model a three-dimensional object by a lamination modeling method, the curable resin being a resin that is cured depending on a predetermined condition, the apparatus comprising:
a plurality of heads for colored inks comprising the curable resin and configured to discharge ink droplets of colored inks having different colors from each other by an inkjet method;
a curing unit configured to cure the curable resin;
a head for support material configured to discharge ink droplets, which become a material of a support layer configured to surround an outer periphery of the three-dimensional object being modeled and to support the three-dimensional object, by the inkjet method, and
a control unit configured to control operations of the plurality of heads for colored inks, the curing unit and the head for support material,
wherein the control unit is configured to enable the head for support material to discharge the ink droplets to an area in which the support layer is to be formed, and
wherein at least when not coloring a surface of the three-dimensional object on the basis of an image prepared in advance, the control unit enables at least one of the heads for colored inks to discharge the ink droplets to the area in which the support layer is to be formed.
